(19) United States
(12) Patent Application Publication
(10) Pub. No.: US 2024/0292264 A1
(43) Pub. Date: Aug. 29, 2024

(54) TRANSMISSION CONTROL PROTOCOL RESET BURST HANDLING

(71) Applicant: Qualcomm Incorporated, San Diego, CA (US)

(72) Inventors: Sitaramanjaneyulu KANAMARLAPUDI, San Diego, CA (US); Harish BHANDIWAD, San Diego, CA (US); Alok MITRA, San Diego, CA (US); Amit Kumar LNU, San Diego, CA (US); Vamsi DOKKU, San Diego, CA (US)

(21) Appl. No.: 18/417,823

(22) Filed: Jan. 19, 2024

Related U.S. Application Data
(60) Provisional application No. 63/486,637, filed on Feb. 23, 2023.

(51) Int. Cl. H04W 28/02; H04L 47/193; H04L 47/32; H04W 28/06

(52) U.S. Cl. CPC H04W 28/0221; H04L 47/193; H04L 47/32; H04W 28/065

(57) ABSTRACT

Various aspects of the present disclosure generally relate to wireless communication. For example, when a modem of a user equipment (UE) receives a burst of reset (RST) packets from an application processor, the modem may send only one RST packet and prune the remaining RST packets in the RST packet burst, or may send only one RST packet in a time period in cases where the RST packet burst is associated with a closed TCP connection and/or a TCP connection for which an RST packet has already been sent to a network node. Additionally or alternatively, the modem may inform the application processor to prune RST packets associated with the closed TCP connections and/or the TCP connections for which an RST packet has already been sent. Furthermore, similar techniques may be applied at the network node to avoid sending downlink traffic that is likely to result in uplink RST traffic.

### CROSS-REFERENCE TO RELATED APPLICATION

This patent application claims priority to U.S. Provisional Patent Application No. 63/486,637, filed on Feb. 23, 2023, entitled “TRANSMISSION CONTROL PROTOCOL RESET BURST HANDLING,” and assigned to the assignee hereof. The disclosure of the prior application is considered part of and is incorporated by reference into this patent application.

### FIELD OF THE DISCLOSURE

Aspects of the present disclosure generally relate to wireless communication and specifically, to techniques and apparatuses associated with transmission control protocol (TCP) reset (RST) burst handling.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

In the transmission control protocol (TCP), a reset (RST) message is a control message that a first device transmits to a second device when the first device receives a packet from a second device and there is no active TCP connection matching the received packet. For example, as a general rule, a first device may send an RST message to a second device in cases where a segment (for example, one or more data packets) arrives at the first device and the segment does not appear to be intended for a current TCP connection. In such a case, the first may send an RST message to indicate that the first device is unable to process the segment and that the TCP connection should be reset (and the RST message should not be sent unless the segment apparently is clearly not intended for a current TCP connection). The RST message can generally be sent at any time during a TCP connection (for example, to recover from an error, such as a device crashing or losing network connectivity), and the RST message causes the connection to be immediately terminated without following the usual TCP procedure to gracefully shut down a TCP connection (for example, where a first device that wants to close a TCP connection sends a finish (FIN) message to a second device, and the second device responds to the FIN message with an acknowledgement (ACK) and its own FIN message). The RST message is typically sent in response to a packet that violates the TCP protocol, such as a packet with an invalid sequence number or an unexpected flag combination. However, in cases where a user equipment (UE) accesses data from an application server via a wireless network, such as an LTE network or an NR network, there are circumstances where a UE may continue to receive downlink packets associated with a TCP connection that has been closed from the UE perspective (for example, after a FIN message has been sent), which may result in the UE transmitting a flood of uplink RST packets that can cause processing overload at the UE, increased power consumption at the UE, increased usage of radio resources, radio link failure (RLF), and/or data stalls.

For example, in a typical topology, data packets associated with a TCP connection may be buffered in a TCP/Internet Protocol (TCP/IP) stack of the application server, at one or more backhaul entities, at one or more core network devices, at a central unit (CU) and/or a distributed unit (DU) of a network node, at a Layer 1 (L1) hybrid automatic repeat request (HARQ) entity of the network node, at an L1 HARQ entity of the UE, and at various levels within the UE. Accordingly, in cases where a TCP connection is closed from a perspective of an application running at the UE, there can be a significant number of downlink packets that are already buffered for transmission on the network-side, which may result in a large number of downlink packets accumulating in a modem of the UE and/or being received at the TCP stack of the UE. For example, due to various delays in the end-to-end topology of a TCP connection, various entities in the downlink data path may continue to forward or transmit buffered downlink data packets before receiving any notification that the TCP connection has been closed. As a result, when the UE receives downlink data packets for a closed TCP connection, the TCP/IP stack of the UE may generate RST packets that are sent on the uplink to inform the peer(s) on the wireless network about the non-existent TCP connection.

In cases where there is a large number of RST packets sent on the uplink, the modem and interconnects of the UE (for example, between the modem and an application processor) may be continuously awake, which increases power consumption and bandwidth usage at the UE. Furthermore, when the modem of the UE processes the bursts of RST packets, the UE may need to report a buffer status to a Layer 2 (L2) entity and transmit a scheduling request (SR) and buffer status report (BSR) to the network node based on the buffer state of the UE, which can result in over-the-air (OTA) grants wasting radio resources. In addition, when the UE performs uplink OTA transmission of the RST packets, the uplink transmission consumes power and prevents the UE from entering a discontinuous reception (DRX) state that may otherwise allow the UE to conserve power. Further still, the RST packets may preempt other traffic, which may increase latency or otherwise impact performance for the other traffic, and/or may cause an RLF or data stall that needs to be recovered through a modem reset (which is an undesirable key performance indicator (KPI)) or by forcing the UE to a different (sub-optimal) radio access technology, such as moving from millimeter wave to sub-6 gigahertz.

### SUMMARY

Some aspects described herein relate to a user equipment (UE) for wireless communication. The UE may include at least one memory and at least one processor coupled with the at least one memory. The at least one processor may be operable to cause the UE to store information identifying a set of closed transmission control protocol (TCP) connections. The at least one processor may be operable to cause the UE to filter a set of reset (RST) packets queued for uplink transmission by an application processor based at least in part on the set of RST packets being associated with a TCP connection included in the set of closed TCP connections. The at least one processor may be operable to cause the UE to filter a set of downlink packets, received from a network node, based at least in part on the set of downlink packets being associated with a TCP connection included in the set of closed TCP connections.

Some aspects described herein relate to a network node for wireless communication. The network node may include at least one memory and at least one processor coupled with the at least one memory. The at least one processor may be operable to cause the network node to store information identifying a set of TCP connections for which an uplink RST packet has been received from a UE. The at least one processor may be operable to cause the network node to filter a set of downlink packets that are queued for downlink transmission to the UE based at least in part on the set of downlink packets being associated with a TCP connection included in the set of TCP connections for which an uplink RST packet has been received from the UE.

Some aspects described herein relate to a method of wireless communication performed by a UE. The method may include storing information identifying a set of closed TCP connections. The method may include filtering a set of RST packets queued for uplink transmission by an application processor based at least in part on the set of RST packets being associated with a TCP connection included in the set of closed TCP connections. The method may include filtering a set of downlink packets, received from a network node, based at least in part on the set of downlink packets being associated with a TCP connection included in the set of closed TCP connections.

Some aspects described herein relate to a method of wireless communication performed by a network node. The method may include storing information identifying a set of TCP connections for which an uplink RST packet has been received from a UE. The method may include filtering a set of downlink packets that are queued for downlink transmission to the UE based at least in part on the set of downlink packets being associated with a TCP connection included in the set of TCP connections for which an uplink RST packet has been received from the UE.

Some aspects described herein relate to a non-transitory computer-readable medium that stores a set of instructions for wireless communication by a UE. The set of instructions, when executed by one or more processors of the UE, may cause the UE to store information identifying a set of closed TCP connections. The set of instructions, when executed by one or more processors of the UE, may cause the UE to filter a set of RST packets queued for uplink transmission by an application processor based at least in part on the set of RST packets being associated with a TCP connection included in the set of closed TCP connections. The set of instructions, when executed by one or more processors of the UE, may cause the UE to filter a set of downlink packets, received from a network node, based at least in part on the set of downlink packets being associated with a TCP connection included in the set of closed TCP connections.

Some aspects described herein relate to a non-transitory computer-readable medium that stores a set of instructions for wireless communication by a network node. The set of instructions, when executed by one or more processors of the network node, may cause the network node to store information identifying a set of TCP connections for which an uplink RST packet has been received from a UE. The set of instructions, when executed by one or more processors of the network node, may cause the network node to filter a set of downlink packets that are queued for downlink transmission to the UE based at least in part on the set of downlink packets being associated with a TCP connection included in the set of TCP connections for which an uplink RST packet has been received from the UE.

Some aspects described herein relate to an apparatus for wireless communication. The apparatus may include means for storing information identifying a set of closed TCP connections. The apparatus may include means for filtering a set of RST packets queued for uplink transmission by an application processor based at least in part on the set of RST packets being associated with a TCP connection included in the set of closed TCP connections. The apparatus may include means for filtering a set of downlink packets, received from a network node, based at least in part on the set of downlink packets being associated with a TCP connection included in the set of closed TCP connections.

Some aspects described herein relate to an apparatus for wireless communication. The apparatus may include means for storing information identifying a set of TCP connections for which an uplink RST packet has been received from a UE. The apparatus may include means for filtering a set of downlink packets that are queued for downlink transmission to the UE based at least in part on the set of downlink packets being associated with a TCP connection included in the set of TCP connections for which an uplink RST packet has been received from the UE.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram of an example of a core network in accordance with the present disclosure.

FIG. 4 is a diagram illustrating an example of a user plane protocol stack and a control plane protocol stack for a network node and a core network in communication with a UE in accordance with the present disclosure.

FIG. 5 is a diagram illustrating an example of a transmission control protocol (TCP) handshake in accordance with the present disclosure.

FIG. 6 is a diagram illustrating an example of a network-side data path associated with downlink and uplink traffic in accordance with the present disclosure.

FIG. 7 is a diagram illustrating an example of a TCP reset (RST) burst in accordance with the present disclosure.

FIG. 8 is a diagram illustrating an example of a TCP data flow in accordance with the present disclosure.

FIG. 9 is a diagram illustrating an example of end-to-end delays in a wireless network in accordance with the present disclosure.

FIGS. 10-11 are diagrams illustrating examples associated with TCP RST burst handling in accordance with the present disclosure.

FIG. 12 is a flowchart illustrating an example process performed, for example, by a UE in accordance with the present disclosure.

FIG. 13 is a flowchart illustrating an example process performed, for example, by a network node in accordance with the present disclosure.

FIGS. 14-15 are diagrams of example apparatuses for wireless communication in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to techniques to reduce uplink reset (RST) transmissions when a large number of downlink packets arrive at a user equipment (UE) for a transmission control protocol (TCP) connection after the TCP connection has been closed from a perspective of the UE. Some aspects more specifically relate to tracking, in a modem of a UE, a set of closed TCP connections and/or TCP connections for which an RST packet has been sent to a TCP/Internet Protocol (TCP/IP) stack of a network node, and applying one or more techniques to suppress uplink RST transmissions associated with the closed TCP connections and/or TCP connections for which an RST packet has been sent to a TCP/IP stack of a network node. For example, in cases where the modem of the UE receives a burst of RST packets from an application processor, the modem may perform one or more actions to reduce uplink RST traffic in cases where the burst of RST packets is associated with a closed TCP connection and/or a TCP connection for which an RST packet has been sent to a TCP/IP stack of a network node. For example, in some aspects, the modem may send only one of the RST packets and prune the remaining RST packets in the burst of RST packets, or may send only one RST packet in a particular time period (for example, one RST packet every X milliseconds). Additionally or alternatively, the modem may inform the application processor to prune RST packets associated with the closed TCP connections and/or the TCP connections for which an RST packet has already been sent to a TCP/IP stack of a network node. Furthermore, in some aspects, similar techniques may be applied at the network node to avoid sending downlink traffic that is likely to result in uplink RST traffic. For example, the network node may track TCP connections for which a connection closure is received on an uplink, and may filter and/or discard any downlink packets that are associated with a TCP connections for which a connection closure has been received. Additionally or alternatively, the network node may send only one (1) downlink packet out of every N downlink packets or in a particular time period to allow the UE to continue to generate a moderate number of RST packets until the connection closure has been propagated to all nodes in the end-to-end data path.

Particular aspects of the subject matter described in this disclosure can be implemented to realize one or more of the following potential advantages. In some examples, the described techniques can be used to reduce unnecessary uplink RST traffic associated with TCP connections that have been closed from a perspective of an application running on a UE, which may reduce power consumption and increase available bandwidth on an interconnect of the UE (for example, a peripheral component interconnect express (PCIe) interface between the application processor and modem of the UE). Furthermore, reducing uplink RST traffic may reduce a need for the UE to transmit a buffer status report (BSR) and/or scheduling request (SR) to the network and reduce the number of uplink grants that are provided to the UE, which can conserve over-the-air (OTA) radio resources. In addition, the UE may avoid performing uplink OTA transmission of RST packets for closed TCP connections, which may save power, allow the UE to enter a discontinuous reception (DRX) state to save additional power, reduce latency or improve performance for other traffic that no longer has to contend with the uplink RST traffic, and/or avoid modem resets or switches to sub-optimal RATs that may be needed to recover from a radio link failure (RLF) or data stall caused by an RST flood.

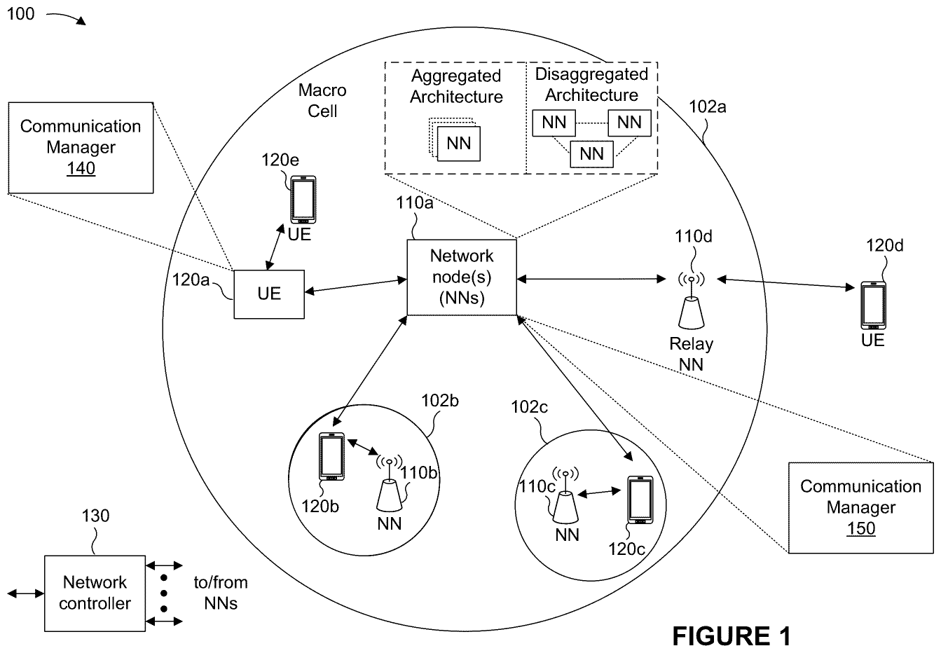

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a UE 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, and/or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), and/or a Non-Real Time (Non-RT) RIC. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may store information identifying a set of closed TCP connections; filter a set of RST packets queued for uplink transmission by an application processor based at least in part on the set of RST packets being associated with a TCP connection included in the set of closed TCP connections; and filter a set of downlink packets, received from a network node 110, based at least in part on the set of downlink packets being associated with a TCP connection included in the set of closed TCP connections. Additionally or alternatively, the communication manager 140 may perform one or more other operations described herein.

In some aspects, the network node 110 may include a communication manager 150. As described in more detail elsewhere herein, the communication manager 150 may store information identifying a set of TCP connections for which an uplink RST packet has been received from a UE; and filter a set of downlink packets that are queued for downlink transmission to the UE based at least in part on the set of downlink packets being associated with a TCP connection included in the set of TCP connections for which an uplink RST packet has been received from the UE. Additionally or alternatively, the communication manager 150 may perform one or more other operations described herein.

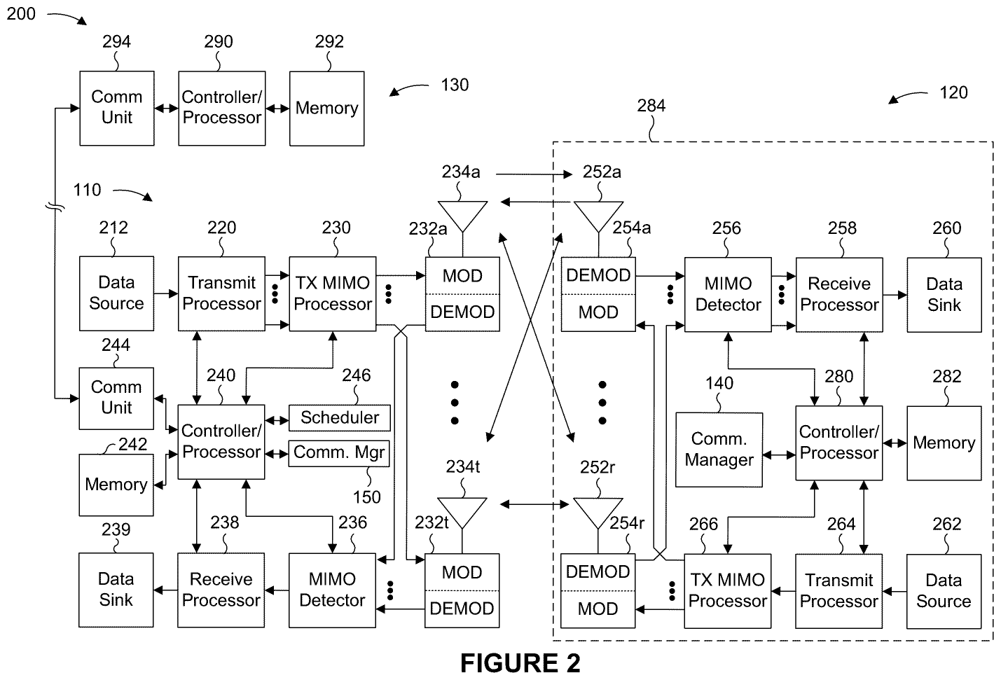

FIG. 2 is a diagram illustrating an example network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers and/or one or more processors. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

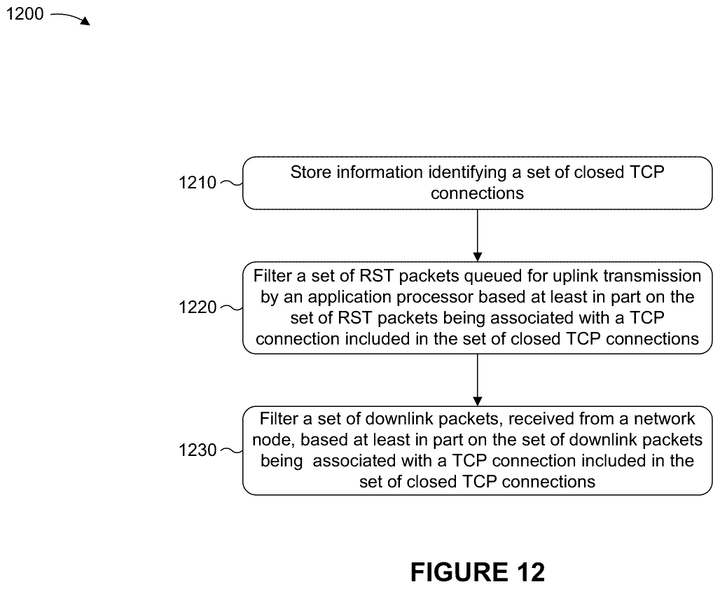

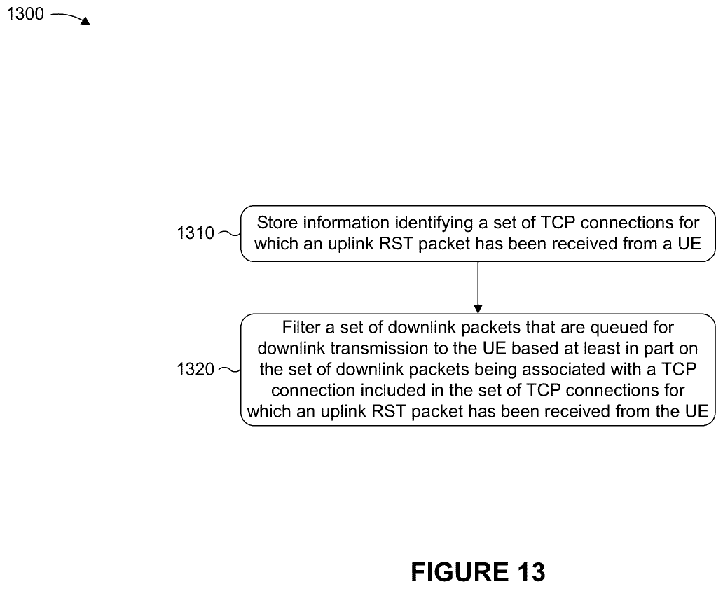

The controller/processor 240 of the network node 110, the controller/processor 280 of the UE 120, or any other component(s) of FIG. 2 may perform one or more techniques associated with TCP RST burst handling, as described in more detail elsewhere herein. For example, the controller/processor 240 of the network node 110, the controller/processor 280 of the UE 120, or any other component(s) of FIG. 2 may perform or direct operations of, for example, process 1200 of FIG. 12, process 1300 of FIG. 13, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1200 of FIG. 12, process 1300 of FIG. 13, or other processes as described herein. In some examples, executing instructions may include running the instructions, converting the instructions, compiling the instructions, or interpreting the instructions, among other examples.

In some aspects, the UE 120 includes means for storing information identifying a set of closed TCP connections; means for filtering a set of RST packets queued for uplink transmission by an application processor based at least in part on the set of RST packets being associated with a TCP connection included in the set of closed TCP connections; and/or means for filtering a set of downlink packets, received from a network node 110, based at least in part on the set of downlink packets being associated with a TCP connection included in the set of closed TCP connections. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for storing information identifying a set of TCP connections for which an uplink RST packet has been received from a UE 120; and/or means for filtering a set of downlink packets that are queued for downlink transmission to the UE 120 based at least in part on the set of downlink packets being associated with a TCP connection included in the set of TCP connections for which an uplink RST packet has been received from the UE 120. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, and/or one or more RUs).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

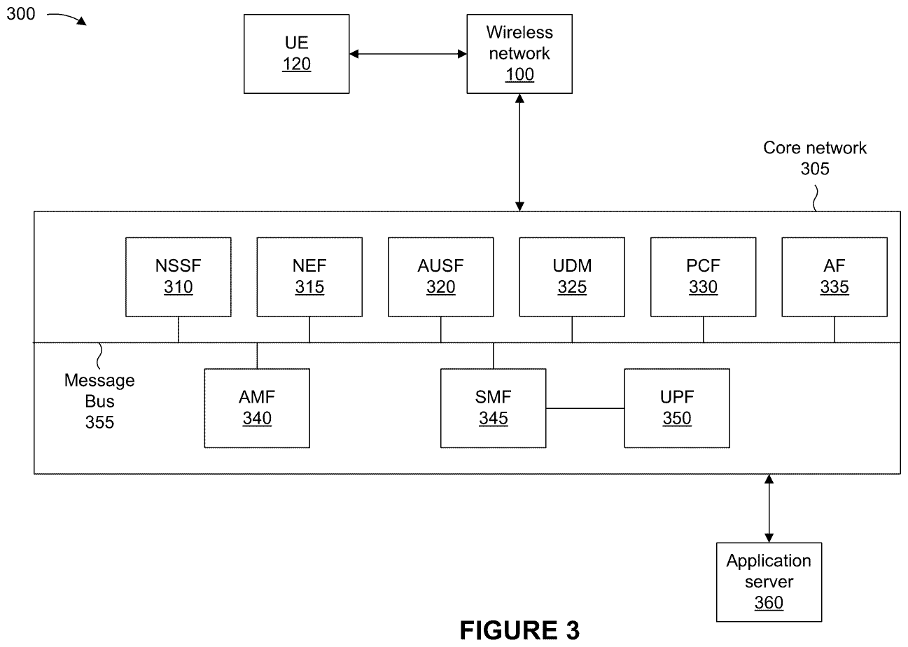

FIG. 3 is a diagram of an example 300 of a core network 305 in accordance with the present disclosure. As shown in FIG. 3, example 300 may include a UE 120, a wireless network 100, and a core network 305. Devices and/or networks of example 300 may interconnect via wired connections, wireless connections, or a combination thereof.

The wireless network 100 may support, for example, a cellular radio access technology (RAT). The wireless network 100 may include one or more network nodes, such as base stations (for example, base transceiver stations, radio base stations, node Bs, eNodeBs (eNBs), gNodeBs (gNBs), base station subsystems, cellular sites, cellular towers, access points, TRPs, radio access nodes, macrocell base stations, microcell base stations, picocell base stations, femtocell base stations, or similar types of devices) and other network nodes that can support wireless communication for the UE 120. The wireless network 100 may transfer traffic between the UE 120 (for example, using a cellular RAT), one or more network nodes (for example, using a wireless interface or a backhaul interface, such as a wired backhaul interface), and/or the core network 305. The wireless network 100 may provide one or more cells that cover geographic areas.

In some examples, the wireless network 100 may perform scheduling and/or resource management for the UE 120 covered by the wireless network 100 (for example, the UE 120 covered by a cell provided by the wireless network 100). In some aspects, the wireless network 100 may be controlled or coordinated by a network controller (for example, network controller 130 of FIG. 1), which may perform load balancing and/or network-level configuration, among other examples. As described above in connection with FIG. 1, the network controller may communicate with the wireless network 100 via a wireless or wireline backhaul. In some aspects, the wireless network 100 may include a network controller, a self-organizing network (SON) module or component, or a similar module or component. Accordingly, the wireless network 100 may perform network control, scheduling, and/or network management functions (for example, for uplink, downlink, and/or sidelink communications of the UE 120 covered by the wireless network 100).

In some examples, the core network 305 may include an example functional architecture in which systems and/or methods described herein may be implemented. For example, the core network 305 may include an example architecture of a fifth generation (5G) next generation (NG) core network included in a 5G wireless telecommunications system. Although the example architecture of the core network 305 shown in FIG. 3 may be an example of a service-based architecture, in some aspects, the core network 305 may be implemented as a reference-point architecture and/or a 4G core network, among other examples.

As shown in FIG. 3, the core network 305 may include various functional elements. The functional elements may include, for example, a network slice selection function (NSSF) 310, a network exposure function (NEF) 315, an authentication server function (AUSF) 320, a unified data management (UDM) component 325, a policy control function (PCF) 330, an application function (AF) 335, an access and mobility management function (AMF) 340, a session management function (SMF) 345, and/or a user plane function (UPF) 350, among other examples. The functional elements may be communicatively connected via a message bus 355. Each of the functional elements shown in FIG. 3 may be implemented on one or more devices associated with a wireless telecommunications system. In some implementations, one or more of the functional elements may be implemented on physical devices, such as an access point, a base station, and/or a gateway, among other examples. In some implementations, one or more of the functional elements may be implemented on a computing device of a cloud computing environment.

The NSSF 310 may include one or more devices that select network slice instances for the UE 120. Network slicing is a network architecture model in which logically distinct network slices operate using common network infrastructure. For example, several network slices may operate as isolated end-to-end networks customized to satisfy different target service standards for different types of applications executed, at least in part, by the UE 120 and/or communications to and from the UE 120. Network slicing may efficiently provide communications for different types of services with different service standards.

The NSSF 310 may determine a set of network slice policies to be applied at the wireless network 100. For example, the NSSF 310 may apply one or more UE route selection policy (URSP) rules. In some aspects, the NSSF 310 may select a network slice based on a mapping of a data network name (DNN) field included in a route selection description (RSD) to the DNN field included in a traffic descriptor selected by the UE 120. By providing network slicing, the NSSF 310 allows an operator to deploy multiple substantially independent end-to-end networks potentially with the same infrastructure. In some implementations, each slice may be customized for different services.

The NEF 315 may include one or more devices that support exposure of capabilities and/or events in the wireless telecommunications system to help other entities in the wireless telecommunications system discover network services. The AUSF 320 may include one or more devices that act as an authentication server and support the process of authenticating the UE 120 in the wireless telecommunications system.

The UDM 325 may include one or more devices that store user data and profiles in the wireless telecommunications system. In some aspects, the UDM 325 may be used for fixed access and/or mobile access, among other examples, in the core network 305.

The PCF 330 may include one or more devices that provide a policy framework that incorporates network slicing, roaming, packet processing, and/or mobility management, among other examples. In some aspects, the PCF 330 may include one or more URSP rules used by the NSSF 310 to select network slice instances for the UE 120.

The AF 335 may include one or more devices that support application influence on traffic routing, access to the NEF 315, and/or policy control, among other examples.

The AMF 340 may include one or more devices that act as a termination point for non-access stratum (NAS) signaling and/or mobility management, among other examples. In some aspects, the AMF may request the NSSF 310 to select network slice instances for the UE 120 (for example, at least partially in response to a request for data service from the UE 120).

The SMF 345 may include one or more devices that support the establishment, modification, and release of communication sessions in the wireless telecommunications system. For example, the SMF 345 may configure traffic steering policies at the UPF 350 and/or enforce user equipment IP address allocation and policies, among other examples. In some aspects, the SMF 345 may provision the network slice instances selected by the NSSF 310 for the UE 120.

The UPF 350 may include one or more devices that serve as an anchor point for intra-RAT and/or inter-RAT mobility. In some aspects, the UPF 350 may apply rules to packets, such as rules pertaining to packet routing, traffic reporting, and/or handling user plane quality of service (QoS), among other examples.

The message bus 355 may be a logical and/or physical communication structure for communication among the functional elements. Accordingly, the message bus 355 may permit communication between two or more functional elements, whether logically (for example, using one or more application programming interfaces (APIs), among other examples) and/or physically (for example, using one or more wired and/or wireless connections).

As further shown in FIG. 3, the core network 305 may provide access to an application server 360 that provides one or more specific services to users over a mobile network. For example, the application server 360 is a network element that hosts and manages a set of network-based applications and services, such as mobile messaging, multimedia messaging, presence, and/or video services, among others. In some examples, the application server 360 provides a centralized location to manage the applications and services delivered to end users, and interacts with one or more network elements in the core network 305 to provide end-to-end service delivery to end users. Furthermore, in addition to providing a software infrastructure to host the applications and services delivered to end users, the application server 360 may provide other capabilities such as authentication, authorization, and accounting for users accessing the applications and services and/or support for billing and charging functions.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally or alternatively, a set of devices (for example, one or more devices) of example 300 may perform one or more functions described as being performed by another set of devices of example environment 300.

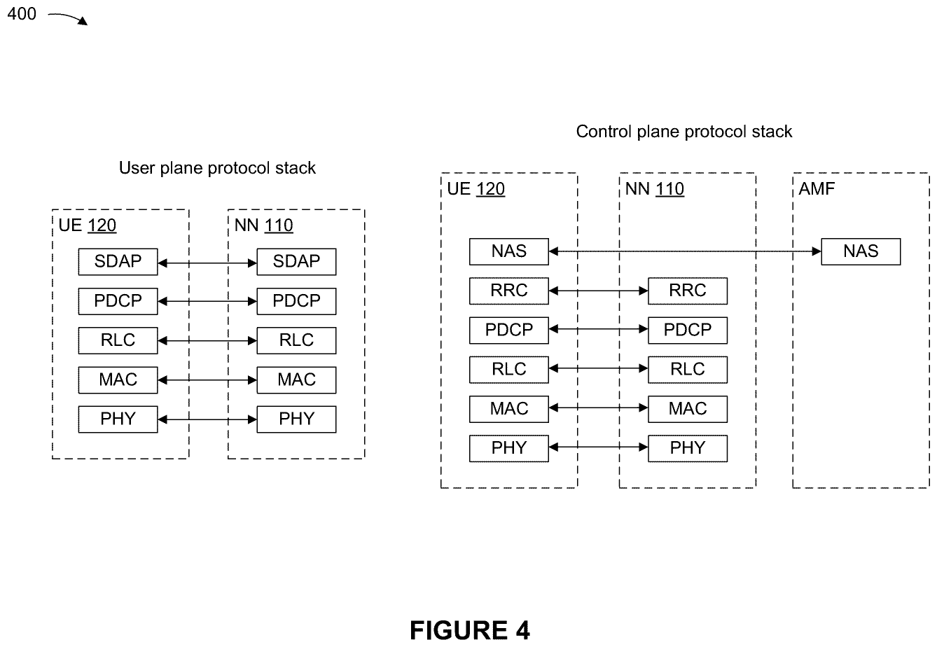

FIG. 4 is a diagram illustrating an example 400 of a user plane protocol stack and a control plane protocol stack for a network node 110 and a core network in communication with a UE 120 in accordance with the present disclosure. In some aspects, the network node 110 may include a plurality of network nodes 110. In some aspects, protocol stack functions of the network node 110 may be distributed across multiple network nodes 110. For example, a first network node 110 may implement a first layer of a protocol stack and a second network node 110 may implement a second layer of the protocol stack. The distribution of the protocol stack across network nodes (in examples where the protocol stack is distributed across network nodes) may be based at least in part on a functional split, as described elsewhere herein. It should be understood that references to “a network node 110” or “the network node 110” can, in some aspects, refer to multiple network nodes.

On the user plane, the UE 120 and the network node 110 may include respective physical (PHY) layers, medium access control (MAC) layers, radio link control (RLC) layers, packet data convergence protocol (PDCP) layers, and service data adaptation protocol (SDAP) layers. A user plane function may handle transport of user data between the UE 120 and the network node 110. On the control plane, the UE 120 and the network node 110 may include respective radio resource control (RRC) layers. Furthermore, the UE 120 may include an NAS layer in communication with an NAS layer of an AMF. The AMF may be associated with a core network associated with the network node 110, such as a 5G core network (5GC) or a next-generation radio access network (NG-RAN). A control plane function may handle transport of control information between the UE 120 and the core network. Generally, a first layer is referred to as higher than a second layer if the first layer is further from the PHY layer than the second layer. For example, the PHY layer may be referred to as a lowest layer, and the SDAP/PDCP/RLC/MAC layer may be referred to as higher than the PHY layer and lower than the RRC layer. An application (APP) layer, not shown in FIG. 4, may be higher than the SDAP/PDCP/RLC/MAC layer. In some cases, an entity may handle the services and functions of a given layer (for example, a PDCP entity may handle the services and functions of the PDCP layer), although the description herein refers to the layers themselves as handling the services and functions.

The RRC layer may handle communications related to configuring and operating the UE 120, such as: broadcast of system information related to the access stratum (AS) and the NAS; paging initiated by the 5GC or the NG-RAN; establishment, maintenance, and release of an RRC connection between the UE 120 and the NG-RAN, including addition, modification, and release of carrier aggregation, as well as addition, modification, and release of dual connectivity; security functions including key management; establishment, configuration, maintenance, and release of signaling radio bearers (SRBs) and data radio bearers (DRBs); mobility functions (for example, handover and context transfer, UE cell selection and reselection and control of cell selection and reselection, inter-RAT mobility); QoS management functions; UE measurement reporting and control of the reporting; detection of and recovery from RLF; and NAS message transfer between the NAS layer and the lower layers of the UE 120. The RRC layer is frequently referred to as Layer 3 (L3).

The SDAP layer, PDCP layer, RLC layer, and MAC layer may be collectively referred to as Layer 2 (L2). Thus, in some cases, the SDAP, PDCP, RLC, and MAC layers are referred to as sublayers of Layer 2. On the transmitting side (for example, if the UE 120 is transmitting an uplink communication or the network node 110 is transmitting a downlink communication), the SDAP layer may receive a data flow in the form of a QoS flow. A QoS flow is associated with a QoS identifier, which identifies a QoS parameter associated with the QoS flow, and a QoS flow identifier (QFI), which identifies the QoS flow. Policy and charging parameters are enforced at the QoS flow granularity. A QoS flow can include one or more service data flows (SDFs), so long as each SDF of a QoS flow is associated with the same policy and charging parameters. In some aspects, the RRC/NAS layer may generate control information to be transmitted and may map the control information to one or more radio bearers for provision to the PDCP layer.

The SDAP layer, or the RRC/NAS layer, may map QoS flows or control information to radio bearers. Thus, the SDAP layer may be said to handle QoS flows on the transmitting side. The SDAP layer may provide the QoS flows to the PDCP layer via the corresponding radio bearers. The PDCP layer may map radio bearers to RLC channels. The PDCP layer may handle various services and functions on the user plane, including sequence numbering, header compression and decompression (if robust header compression is enabled), transfer of user data, reordering and duplicate detection (if in-order delivery to layers above the PDCP layer is required), PDCP protocol data unit (PDU) routing (in case of split bearers), retransmission of PDCP service data units (SDUs), ciphering and deciphering, PDCP SDU discard (for example, in accordance with a timer, as described elsewhere herein), PDCP re-establishment and data recovery for RLC acknowledged mode (AM), and duplication of PDCP PDUs. The PDCP layer may handle similar services and functions on the control plane, including sequence numbering, ciphering, deciphering, integrity protection, transfer of control plane data, duplicate detection, and duplication of PDCP PDUs.

The PDCP layer may provide data, in the form of PDCP PDUs, to the RLC layer via RLC channels. The RLC layer may handle transfer of upper layer PDUs to the MAC and/or PHY layers, sequence numbering independent of PDCP sequence numbering, error correction via automatic repeat requests (ARQ), segmentation and re-segmentation, reassembly of an SDU, RLC SDU discard, and RLC re-establishment.

The RLC layer may provide data, mapped to logical channels, to the MAC layer. The services and functions of the MAC layer include mapping between logical channels and transport channels (used by the PHY layer as described below), multiplexing/demultiplexing of MAC SDUs belonging to one or different logical channels into/from transport blocks (TBs) delivered to/from the physical layer on transport channels, scheduling information reporting, error correction through hybrid ARQ (HARQ), priority handling between UEs by means of dynamic scheduling, priority handling between logical channels of one UE by means of logical channel prioritization, and padding.

The MAC layer may package data from logical channels into TBs, and may provide the TBs on one or more transport channels to the PHY layer. The PHY layer may handle various operations relating to transmission of a data signal, as described in more detail in connection with FIG. 2. The PHY layer is frequently referred to as Layer 1 (L1).

On the receiving side (for example, if the UE 120 is receiving a downlink communication or the network node 110 is receiving an uplink communication), the operations may be similar to those described for the transmitting side, but reversed. For example, the PHY layer may receive TBs and may provide the TBs on one or more transport channels to the MAC layer. The MAC layer may map the transport channels to logical channels and may provide data to the RLC layer via the logical channels. The RLC layer may map the logical channels to RLC channels and may provide data to the PDCP layer via the RLC channels. The PDCP layer may map the RLC channels to radio bearers and may provide data to the SDAP layer or the RRC/NAS layer via the radio bearers.

Data may be passed between the layers in the form of PDUs and SDUs. An SDU is a unit of data that has been passed from a layer or sublayer to a lower layer. For example, the PDCP layer may receive a PDCP SDU. A given layer may then encapsulate the unit of data into a PDU and may pass the PDU to a lower layer. For example, the PDCP layer may encapsulate the PDCP SDU into a PDCP PDU and may pass the PDCP PDU to the RLC layer. The RLC layer may receive the PDCP PDU as an RLC SDU, may encapsulate the RLC SDU into an RLC PDU, and so on. In effect, the PDU carries the SDU as a payload.

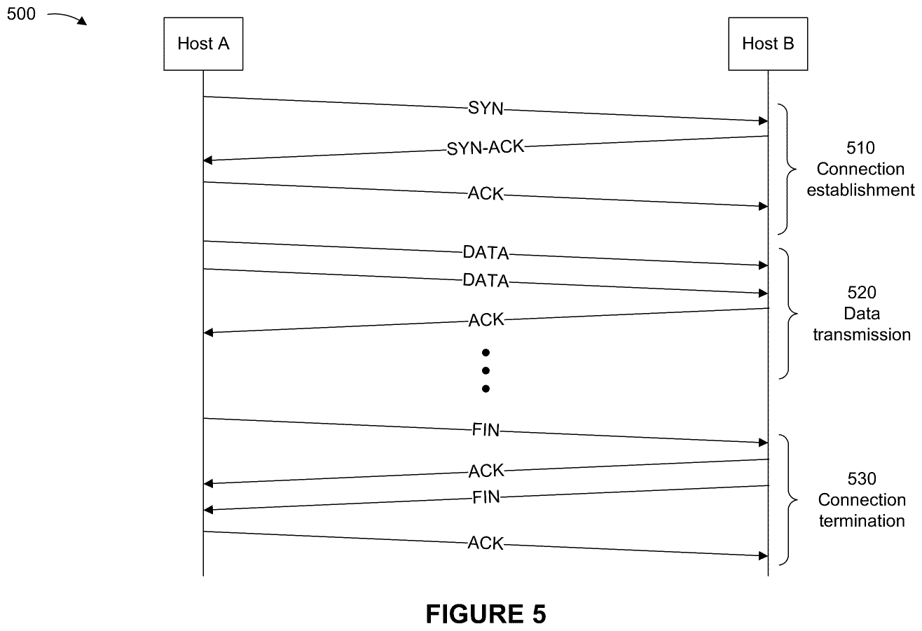

FIG. 5 is a diagram illustrating an example 500 of a TCP handshake in accordance with the present disclosure. In particular, TCP is a transport layer protocol in the Internet Protocol (IP) suite. TCP is generally used to provide reliable, ordered, and error-checked delivery of data between applications running on hosts on the Internet. TCP establishes a connection between two hosts and manages the flow of data over that connection by segmenting data into packets and acknowledging the receipt of each packet. TCP also incorporates mechanisms for congestion control and flow control to ensure that data is transmitted efficiently and without overwhelming network resources, as well as mechanisms for error recovery. TCP is widely used in applications that require a reliable data stream, such as web browsing, email, file transfers, and online gaming.

As shown in FIG. 5, TCP generally defines a three-way connection establishment handshake 510 that is used to establish a TCP connection between a first host (shown as Host A) and a second host (shown as Host B). For example, as shown in FIG. 5, the connection establishment handshake 510 begins with an initiator (for example, Host A in FIG. 5) sending a synchronize (SYN) message to a responder (for example, Host B in FIG. 5), where the SYN message includes a random sequence number that the responder will use to identify subsequent messages from the initiator. A SYN flag may be set in a header of the SYN message. As further shown in FIG. 5, upon receiving the SYN message from the initiator, the responder responds to the initiator with a synchronize-acknowledge (SYN-ACK) message, which includes an acknowledgement number that is one (1) greater than the sequence number received in the SYN message from the initiator. The SYN flag and an ACK flag are both set in the header of the SYN-ACK message. As further shown in FIG. 5, the initiator then sends an acknowledge (ACK) message to the responder, to confirm that the initiator received the SYN-ACK message from the responder. The ACK message sent by the initiator includes an acknowledgement number that is one (1) greater than the sequence number in the SYN-ACK message received from the responder, and the ACK flag is set in the header of the ACK message. Accordingly, the connection establishment handshake 510 is used to establish a reliable TCP connection between the initiator and the responder, where each side can confirm that the other is ready and able to communicate.

As further shown in FIG. 5, after a TCP connection has been established, the two devices may communicate during a data transmission phase 520. For example, as shown, one device may send data packets to the other device, which may respond with an ACK to confirm that the data packets were successfully received. As further shown in FIG. 5, TCP defines a connection termination handshake 530 that is used to gracefully close a TCP connection. For example, the connection termination handshake 530 begins when a first device wants to close the TCP connection and sends a finish (FIN) message to a second device. The second device then responds with an ACK to acknowledge the FIN message, which is followed by a FIN message sent by the second device. The first device then responds with an ACK, and the TCP connection is closed.

Furthermore, TCP defines a RST message that is used to abort a connection that has become corrupted or is otherwise no longer valid (for example, when the device sending the RST message is unable to process received packets and needs to reset the TCP connection, such as following a device crash or lost network connectivity). The RST message can be sent at any time during a TCP connection (although reset events can also be generated by TCP when various error conditions occur), and the RST message causes the connection to be immediately terminated without the graceful connection termination handshake 530. As a general rule, an RST message is sent whenever a segment arrives at a device and the segment apparently is not intended for the current TCP connection. For example, if the TCP connection does not exist (for example, the TCP connection is closed), then an RST message is sent in response to any incoming segment except another reset (for example, providing a mechanism to reject a SYN segment that does not match an existing TCP connection). In cases where the incoming segment has an ACK bit set, the RST message takes a sequence number from the ACK field of the segment, and otherwise has sequence number zero and an ACK field set to the sum of the sequence number and the segment length of the incoming segment. In such cases, the TCP connection associated with the RST message remains in the closed state. In other cases, an RST message may be sent when a connection is in a non-synchronized state and an incoming segment either acknowledges a data packet that has not yet been send (for example, the segment carries an improper ACK) or has a security level or compartment that does not exactly match the level and compartment requested for the connection. Additionally or alternatively, an RST message may be sent when an incoming segment acknowledges a data packet that has not yet been sent (for example, the segment carries an improper ACK) or has a security level or compartment that does not exactly match the level and compartment requested for the connection.

In general, except when a TCP connection is in a SYN-SENT state (for example, a device has sent a SYN message and is waiting for an ACK or other reply to the SYN message), an RST message is validated by checking a sequence field of the RST message. For example, an RST message is valid in cases where a sequence number of the RST message is in an appropriate window. In the SYN-SENT state (for example, an RST message is received in response to an initial SYN message), the RST message is acceptable in cases where the ACK field acknowledges the initial SYN message. The receiver of an RST message first validates the RST message and then changes state. For example, if the receiver was in a listen state, the RST message is ignored. Alternatively, in cases where the receiver was in a SYN-RECEIVED state and had previously been in the listen state, then the receiver returns to the listen state. Otherwise, the receiver aborts the TCP connection and goes to a closed state. If the receiver was in any other state, the receiver aborts the TCP connection, advises the user, and goes to the closed state.

In cases where a UE accesses data from an application server via a wireless network, such as an LTE network or an NR network, there are circumstances where a UE may transmit a flood of RST packets on an uplink, which can result in processing overload at the UE, increased power consumption at the UE, increased usage of radio resources, RLF, and/or data stalls. For example, in a typical topology, data packets associated with a TCP connection may be buffered in a TCP/IP stack of the application server, at one or more backhaul entities, at one or more core network devices, at a CU and/or a DU of a network node, at an L1 HARQ entity of the network node, at an L1 HARQ entity of the UE, and at various levels within the UE. Accordingly, in cases where a TCP connection is closed from a perspective of an application running at the UE, there can be a significant number of downlink packets already buffered for transmission on the network-side, which may result in a large number of downlink packets accumulating in a modem of the UE and/or being received at the TCP stack of the UE. For example, due to various delays in the end-to-end topology of a TCP connection, various entities in the downlink data path may continue to send buffered downlink data packets before receiving any notification that the TCP connection has been closed. As a result, when the UE receives downlink data packets for a closed TCP connection, the TCP/IP stack of the UE may generate RST packets that are sent on the uplink to inform the peer(s) on the wireless network about the non-existent TCP connection.

In cases where there is a large number of RST packets sent on the uplink, the modem and interconnects of the UE (for example, between the modem and an application processor) may be continuously awake, which increases power consumption and bandwidth usage at the UE. Furthermore, when the modem of the UE processes the bursts of RST packets, the UE may need to report a buffer status to an L2 entity and transmit a SR and BSR to the network node based on the buffer state of the UE, which can result in OTA grants wasting radio resources. In addition, when the UE performs uplink OTA transmission of the RST packets, the uplink transmission consumes power and prevents the UE from entering a DRX state that may otherwise allow the UE to conserve power. Further still, the RST packets may preempt other traffic, which may increase latency or otherwise impact performance for the other traffic, and/or may cause an RLF or data stall that needs to be recovered through a modem reset (which is an undesirable KPI) or by forcing the UE to a different (sub-optimal) radio access technology, such as moving from millimeter wave to sub-6 gigahertz.

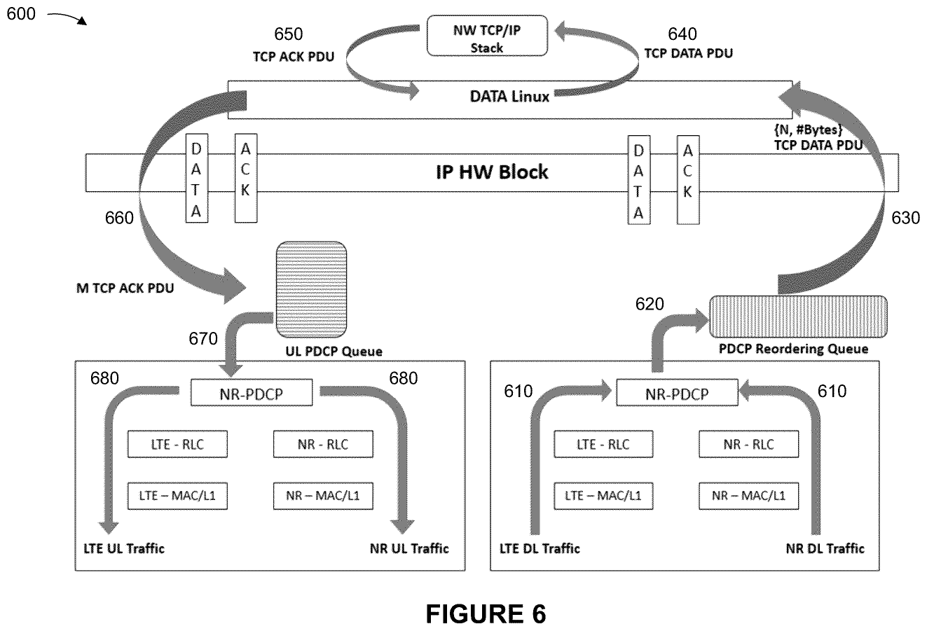

FIG. 6 is a diagram illustrating an example 600 of a network-side data path associated with downlink and uplink traffic in accordance with the present disclosure. For example, as described herein, there are various circumstances in which a TCP connection between a UE and a network application server is closed from a perspective of the UE, and the UE sends information to close the TCP connection (for example, a FIN message) to the network application server. However, because there are various entities in the network-side data path, downlink data packets transmitted by the network may continue to arrive in a TCP stack of the UE after the TCP connection has been closed due to buffering that occurs at the downlink server and/or other network entities.

For example, FIG. 6 depicts a network-side data path that may be implemented in a modem associated with a network node (for example, in a DU or an RU of a network node) that supports an Evolved Universal Mobile Telecommunications System (UMTS) Terrestrial Radio Access Network (E-UTRAN) NR dual connectivity (EN-DC) mode that allows a UE to access a 4G LTE network and a 5G NR network at the same time. However, it will be appreciated that issues with data buffering following a TCP connection closure are also applicable in cases where network-side data path is associated with a standalone LTE network and/or a standalone NR network. As shown in FIG. 6, in a first operation 610, downlink traffic may arrive at the network node (for example, from an application server via one or more core network devices, such as a UPF), and the downlink traffic may be associated with HARQ retransmissions at a MAC level and/or an L1 level, RLC transmissions at an RLC level, and PDCP reordering at a PDCP level. As further shown, in second operation 620, the downlink packets may be reordered in sequence within a PDCP reordering queue. In a third operation 630, the downlink packets may be delivered from the PDCP reordering queue to an application processor that includes a data Linux block and a network TCP/IP stack in N TCP data PDUs (for example, via an IP hardware block). In a fourth operation 640, the data Linux block may forward the N TCP data PDUs to the network TCP/IP stack and the N TCP data PDUs are then transmitted OTA to the UE.

After the UE has received the N TCP data PDUs, the UE may then transmit M ACK messages that are s received at the network TCP/IP stack and processed in a reverse direction. For example, a TCP ACK PDU that arrives at the network TCP/IP stack may be forwarded from the network TCP/IP stack to the data Linux block in a fifth operation 650, and M TCP ACK PDUs may then be stored in an uplink PDCP queue in a sixth operation 660. After the M TCP ACK PDUs are arranged in sequence within the uplink PDCP queue, the TCP ACK PDUs may be sent to a PDCP layer in a seventh operation 670. As further shown, in an eighth operation 680, the uplink traffic (including the M TCP ACK PDUs) is then processed at an RLC layer and a MAC/L1 layer.

Accordingly, because downlink data packets are generally buffered in the PDCP reordering queue and delivered to the network TCP/IP stack for transmission to a UE only when the downlink data packets are in sequence within the PDCP reordering queue, in many cases there may be a significant volume of downlink data buffered in the PDCP reordering queue (for example, several megabytes) at any given time. Furthermore, ACK messages and other uplink messages are received at the network TCP/IP stack only after the downlink data packets have been transmitted to the UE. Accordingly, in cases where the UE sends a FIN message or another suitable TCP connection closure message to the network node, the FIN message or another suitable TCP connection closure message may be buffered in the uplink PDCP queue waiting for an uplink grant. As a result, there may be an interval between a time when a TCP connection closure message is sent by a UE and a time when the TCP connection closure is processed at the network, and during the interval the network node continues to send downlink packets that are buffered in the PDCP reordering queue. Consequently, when the downlink data packets arrive at the TCP/IP stack of the UE after the TCP connection closure was sent to the network node, the downlink data packets are not associated with an active TCP connection and therefore trigger a flood of uplink RST messages.

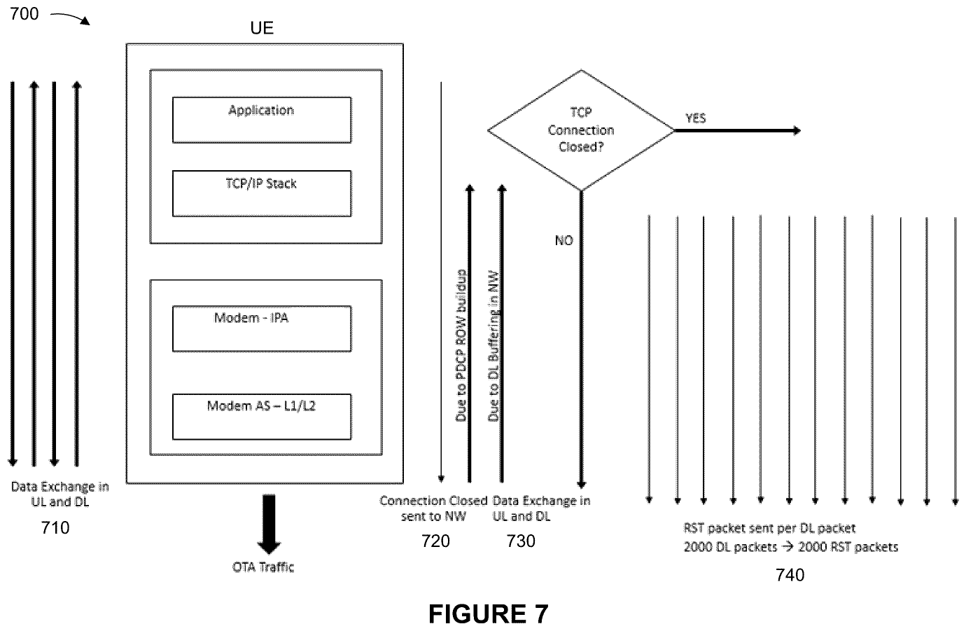

FIG. 7 is a diagram illustrating an example 700 of a TCP RST burst in accordance with the present disclosure. As shown in FIG. 7, a UE may include various components that are used to send OTA traffic to and receive OTA traffic from a network node. For example, as shown, the UE may include a modem associated with L1 and L2 components that implement a radio protocol, and the modem further includes an IP accelerator above the L1 and L2 components to increase a data rate at which data is provided from the modem to an application processor, TCP/IP stack, and endpoint application on the UE. As shown in FIG. 7, in a first phase 710, the UE may communicate with a network node to exchange data associated with an active TCP connection on an uplink and a downlink. During the first phase 710, the UE may send one or more uplink data packets associated with the active TCP connection to the network node, and the network node may respond with one or more ACKs to confirm that the one or more uplink data packets were successfully received. Furthermore, in a downlink direction, the network node may send one or more downlink data packets associated with the active TCP connection to the UE, and the UE may respond with one or more ACKs to confirm that the one or more downlink data packets were successfully received.

As further shown in FIG. 7, in an operation 720, the UE may send a TCP connection closure message to the network node (for example, a FIN message) based on the application running on the UE closing the TCP connection. At this point in time, from a perspective of the application running on the UE, the TCP connection is closed. However, in a second phase 730, the network node may continue to send downlink data packets to the UE (for example, due to a buildup of downlink packets that are buffered in a PDCP reordering queue and/or downlink buffering at other network entities). Accordingly, in cases where one or more downlink data packets associated with a TCP connection arrive at the TCP/IP stack associated with the UE after the TCP connection closure message was sent to close the TCP connection, from a perspective of the application running on the UE, the downlink data packets are associated with a TCP connection that no longer exists or is otherwise invalid from the perspective of the application running on the UE. As a result, in a third phase 740, the UE may send an uplink RST packet to the network node for each downlink packet received at the UE that is associated with the closed TCP connection (for example, receiving 2000 downlink packets associated with a TCP connection after the TCP connection closure message was sent to close the TCP connection may result in 2000 uplink RST packets).

As described herein, when there are a large number of RST packets being sent on the uplink, the modem and interconnects of the UE (for example, between the modem and an application processor) may be continuously awake, which increases power consumption and bandwidth usage at the UE. Furthermore, when the modem of the UE processes the bursts of RST packets, the UE may need to report a buffer status to an L2 entity and transmit an SR/BSR to the network node based on the buffer state of the UE, which can result in OTA grants wasting radio resources. In addition, when the UE performs uplink OTA transmission of the RST packets, the uplink transmission consumes power and prevents the UE from entering a DRX state that may otherwise allow the UE to conserve power. Further still, the RST packets may preempt other traffic, which may increase latency or otherwise impact performance for the other traffic, and/or may cause an RLF or data stall that needs to be recovered through a modem reset (which is an undesirable KPI) or by forcing the UE to a different (sub-optimal) RAT.

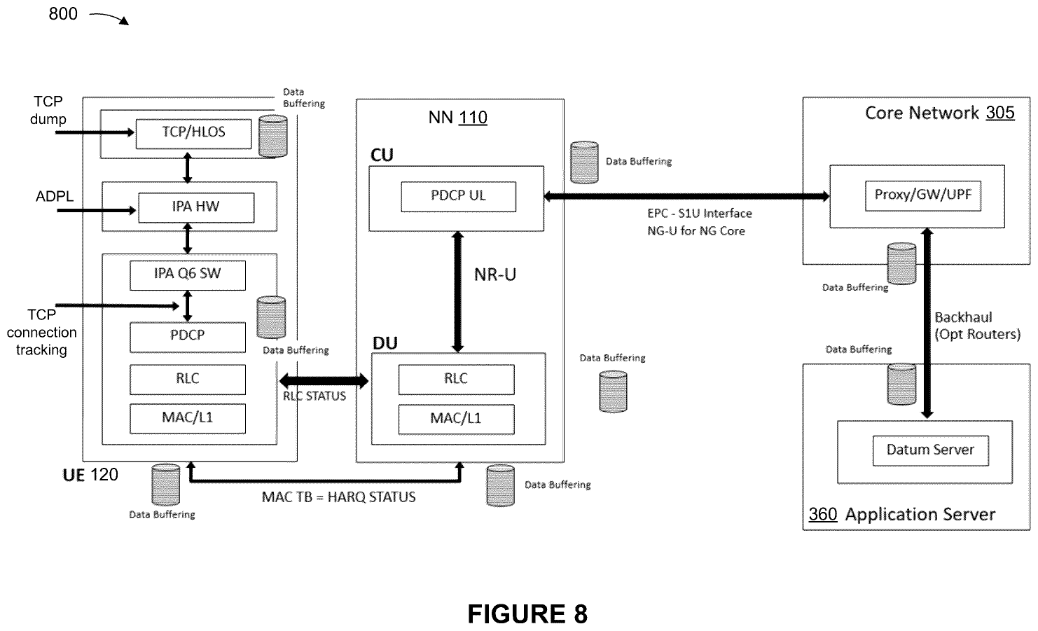

FIG. 8 is a diagram illustrating an example 800 of a TCP data flow in accordance with the present disclosure. As shown in FIG. 8, in example 800, a TCP connection may be established between a UE 120 and an application server 360, and downlink and uplink traffic associated with the TCP connection may be sent between the UE 120 and the application server 360 via a network node 110 and a core network 305. Furthermore, there are various locations in the end-to-end pipeline where data associated with the TCP connection is buffered, which can create conditions that may lead to the UE 120 transmitting an uplink RST burst.

For example, as shown in FIG. 8, the application server 360 may include a datum server, which may host one or more applications or services that are delivered to the UE 120, and the datum server may connect to one or more network elements in the core network 305 (for example, a proxy server, a gateway, or a UPF) over a backhaul. Accordingly, as shown in FIG. 8, data associated with the TCP connection between the UE 120 and the application server 360 may be buffered at the datum server and at the one or more network elements in the core network 305. Furthermore, as shown, the core network 305 may connect to a CU of the network node 110 via an S1U interface for an Evolved Packet Core (EPC) or an NG-U interface for an NG Core, and data associated with the TCP connection between the UE 120 and the application server 360 may be buffered at various entities within the network node 110. For example, as shown, data buffering may occur at a PDCP layer of the CU and at various entities of a DU that communicates with the CU via an NR-U or Xn interface. For example, data buffering may occur at an RLC layer of the DU and a MAC/L1 level of the DU and/or an RU of the network node 110. The data that is buffered at the MAC/L1 level is then sent OTA to the UE 120 and buffered at a MAC/L1 entity of the UE 120. The data is then buffered at a PDCP layer after reassembly reordering at the RLC layer, and delivered over hardware to a high-level operating system (HLOS) stack where the data is further buffered in a TCP window where the data is consumed if the packets are all in sequence.

Accordingly, as shown in FIG. 8, there are various locations and/or entities within the end-to-end pipeline where data associated with a TCP connection may be buffered, including at the application server 360, a UPF, a PDCP layer of a CU of a network node 110, an RLC layer of a DU of a network node 110, an L1 HARQ entity of the network node 110, an L1 HARQ entity of the UE 120, a PDCP layer of the UE 120, a TCP stack of the UE 120, and an endpoint application running on the UE 120. As a result, when the application running on the UE 120 initiates a FIN message or other connection closure message to close a TCP connection, the FIN message or other connection closure message has to pass through buffers at the TCP stack of the UE 120, the PDCP layer of the UE 120, the MAC/L1 entities of the UE 120, the MAC/L1 entities of the network node 110, the RLC layer of the network node 110, the PDCP layer of the network node 110, the core network 305, and the application server 360 before the FIN message or TCP connection closure message is processed and the application server 360 becomes aware that the TCP connection has been closed by the UE 120. However, by the time that the FIN message or TCP connection closure message arrives at the application server 360, downlink data packets may be buffered at the core network 305 and the network node 110, which will deliver the downlink data packets to an intended receiver because the core network 305 and the network node 110 are unaware of the status of the associated TCP connection (for example, only the TCP stack of the UE 120 and the TCP stack of the application server 360 know whether the TCP connection is active). As a result, when the buffered downlink data packets are delivered to the UE 120, the TCP stack of the UE 120 will generate an RST packet for each downlink data packet that is associated with a closed TCP connection, which can result in a flood of RST packets.

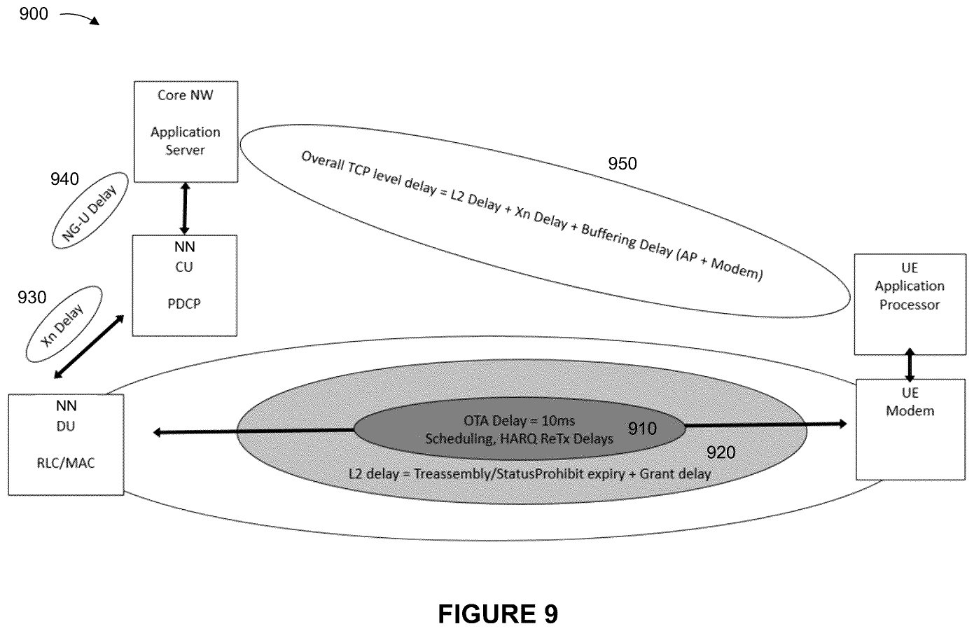

FIG. 9 is a diagram illustrating an example 900 of end-to-end delays in a wireless network in accordance with the present disclosure. For example, FIG. 9 depicts various entities associated with an end-to-end data flow for a TCP connection that is established between an application processor on a UE and an application server that is connected to a core network. In particular, as shown in FIG. 9, the end-to-end data flow for a TCP connection may be associated with an OTA delay 910 between a UE and a DU or RU of a network node, which may typically on an order of about 10 milliseconds (for example, due to scheduling and/or HARQ retransmission delays). Furthermore, the end-to-end data flow may be associated with an L2 delay 920, which may be caused by RLC ARQ delays associated with waiting for reassembly and/or status prohibit timers to expire, PDCP reordering delays based on a window size and/or a reordering timer, BSR and/or SR opportunities, and/or uplink grant delays. Furthermore, the end-to-end data flow may include interconnect delays between an application processor and modem of the UE, an Xn delay 930 associated with communication between a DU and a CU of a network node, and an NG-U delay 940 associated with communication between the CU of the network node and a core network that connects to an application server.

Accordingly, an overall TCP level delay 950 may be a sum of the various delays in the end-to-end data flow, which may include various delays associated with the UE and various network delays. For example, as described herein, the UE delays may include HARQ retransmission delays, RLC ARQ delays, PDCP reordering delays, interconnect delays, BSR/SR opportunity delays, and/or uplink grant delays, and the network delays may include NG-U delays, NR-U delays, downlink scheduling delays, RLC retransmission delays, HARQ retransmission delays, and/or packet delays due to buffer underrun and/or overrun issues. For example, in a typical scenario, a reordering timer may have a value in in a range from 200 ms to 300 ms, and reassembly and status prohibit timers may have values between 20 ms to 50 ms, which can typically result in about 200 ms worth of data buffering in a reordering window at a PDCP level. As a result, a substantial volume of downlink traffic can be delivered to a TCP stack of the UE in a short time period. As described herein, the downlink traffic could be associated with a TCP connection that has been closed from a perspective of the UE, which may then cause an uplink RST flood associated with various performance drawbacks.

Accordingly, various aspects described herein relate generally to techniques to reduce uplink RST transmissions when a large number of downlink packets arrive at a UE for a TCP connection after the TCP connection has been closed from a perspective of the UE. Some aspects more specifically relate to tracking, in a modem of a UE, a set of closed TCP connections and/or TCP connections for which an RST packet has been sent to a TCP/IP stack of a network node, and applying one or more techniques to suppress uplink RST transmissions associated with the closed TCP connections and/or TCP connections for which an RST packet has been sent to a TCP/IP stack of a network node. For example, in cases where the modem of the UE receives a burst of RST packets from an application processor, the modem may perform one or more actions to reduce uplink RST traffic in cases where the burst of RST packets is associated with a closed TCP connection and/or a TCP connection for which an RST packet has been sent to a TCP/IP stack of a network node. For example, in some aspects, the modem may send only one of the RST packets and prune the remaining RST packets in the burst of RST packets, or may send only one RST packet in a particular time period (for example, one RST packet every X milliseconds). Additionally or alternatively, the modem may inform the application processor to prune RST packets associated with the closed TCP connections and/or the TCP connections for which an RST packet has already been sent to a TCP/IP stack of a network node. Furthermore, in some aspects, similar techniques may be applied at the network node to avoid sending downlink traffic that is likely to result in uplink RST traffic. For example, the network node may track TCP connections for which a connection closure is received on an uplink, and may filter and/or discard any downlink packets that are associated with a TCP connections for which a connection closure has been received. Additionally or alternatively, the network node may send only one (1) downlink packet out of every N downlink packets or in a particular time period to allow the UE to continue to generate a moderate number of RST packets until the connection closure has been propagated to all nodes in the end-to-end data path.

Particular aspects of the subject matter described in this disclosure can be implemented to realize one or more of the following potential advantages. In some examples, the described techniques can be used to reduce unnecessary uplink RST traffic associated with TCP connections that have been closed from a perspective of an application running on a UE, which may reduce power consumption and increase available bandwidth on an interconnect of the UE (for example, a PCIe interface between the application processor and modem of the UE). Furthermore, reducing uplink RST traffic may reduce a need for the UE to transmit a BSR and/or SR to the network and reduce the number of uplink grants that are provided to the UE, which can conserve OTA radio resources. In addition, the UE may avoid performing uplink OTA transmission of RST packets for closed TCP connections, which may save power, allow the UE to enter a DRX state to save additional power, reduce latency or improve performance for other traffic that no longer has to contend with the uplink RST traffic, and/or avoid modem resets or switches to sub-optimal RATs that may be needed to recover from an RLF or data stall caused by an RST flood.

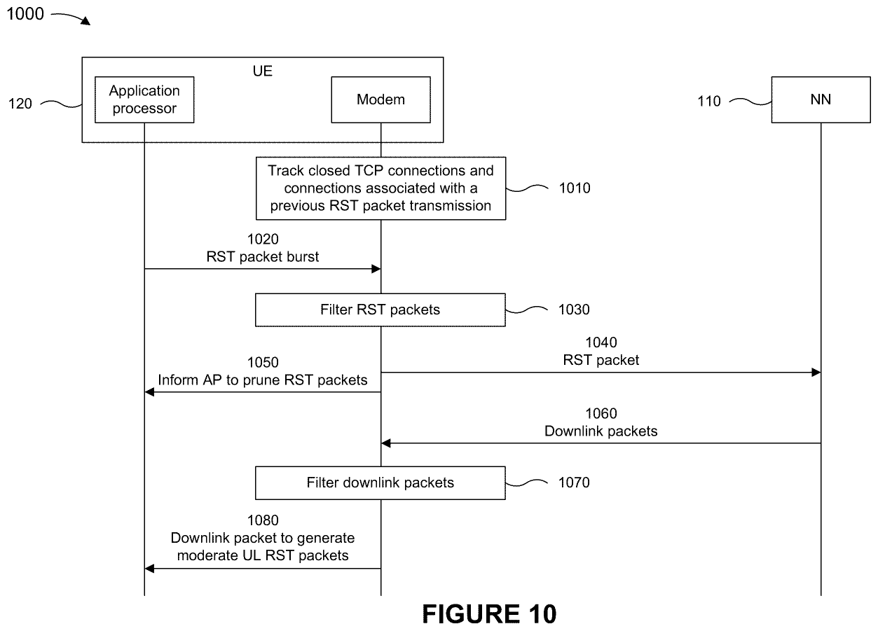

FIG. 10 is a diagram illustrating an example 1000 associated with TCP RST burst handling, in accordance with the present disclosure. As shown in FIG. 10, example 1000 includes communication between a UE 120 and a network node 110. As shown in FIG. 10, the UE 120 may include an application processor and a modem. In some aspects, the UE 120 and the network node 110 may communicate in a wireless network, such as wireless network 100. The UE 120 and the network node 110 may communicate via a wireless access link, which may include an uplink and a downlink.

As shown in FIG. 10, in a first operation 1010, the modem of the UE 120 may track a set of closed TCP connections and TCP connections associated with a previous RST packet transmission. For example, in some aspects, the modem may generally be equipped with a capability to track one or more active TCP connections for various radio level enhancements, such as ACK coalescing and ACK shaping, in order to smoothen buffers in the UE 120 (for example, to prevent buffer underrun and/or buffer overrun issues). For example, when tracking active TCP connections, the number of ACKs that the UE 120 sends to the network node 110 may impact the amount of scheduling that is received on a downlink, whereby the ACK coalescing and ACK shaping techniques may be used to smoothen the uplink ACKs to regulate a rate at which traffic is received in the downlink direction. Accordingly, the modem of the UE 120 may have capabilities to track certain parameters related to active TCP connections, and such capabilities may be extended to track closed TCP connections and/or TCP connections for which an RST packet has been sent to the network node 110 in order to reduce uplink RST transmissions. For example, when the modem of the UE 120 receives a FIN message or another suitable uplink message to close a TCP connection, the modem may store information that identifies the closed TCP connection. Similarly, when the modem of the UE 120 receives an RST message from the application processor (for example, in reply to a downlink packet that does not match an existing or active TCP connection), the modem may store information that identifies the TCP connection associated with the RST message. Accordingly, the modem of the UE 120 may use TCP connection tracking capabilities to track a set of closed TCP connections, which may include one or more TCP connections that were closed within a threshold time period and/or one or more TCP connections associated with a previous uplink RST packet transmission. For example, in some aspects, the set of closed TCP connections may be tracked by storing a list or other suitable information that identifies the one or more TCP connections that were closed within a threshold time period and/or one or more TCP connections associated with a previous uplink RST packet transmission, which can then be used to reduce uplink RST activity associated with any TCP connections in the set of closed TCP connections.

For example, in a second operation 1020, the modem of the UE 120 may receive an uplink RST packet burst, which may generally include a set of RST packets associated with a TCP connection. In some aspects, in a third operation 1030, the modem of the UE 120 may filter the set of RST packets based at least in part on the set of RST packets being associated with a TCP connection included in the set of closed TCP connections. For example, in cases where the set of RST packets is associated with a TCP connection that was closed within a threshold time period or a TCP connection for which an RST packet has already been sent to the network node 110, the modem of the UE 120 may filter the set of uplink RST packets to reduce the volume of uplink RST traffic. For example, in some aspects, the modem may select one RST packet in the set of RST packets associated with the TCP connection to transmit to the network node 110, and may prune or otherwise discard all remaining RST packets associated with the same TCP connection (for example, the modem may transmit one RST packet out of every N RST packets associated with the same TCP connection, and may prune the remaining RST packets). Additionally or alternatively, the modem may select one RST packet in the set of RST packets associated with the TCP connection to transmit to the network node 110 within a time period, and may prune or otherwise discard all remaining RST packets associated with the same TCP connection prior to the time period expiring (for example, the modem may transmit one RST packet associated with the same TCP connection every X ms, and may prune the remaining RST packets associated with the TCP connection).

Accordingly, in a fourth operation 1040, the UE 120 may transmit, via the modem, the one RST packet selected for transmission to the network node 110, and may drop, discard, or otherwise prune all remaining RST packets in the burst that are associated with the same TCP connection. Additionally or alternatively, in a fifth operation 1050, the modem may send a message to the application processor to prune further RST packets associated with the TCP connection in order to reduce the RST traffic being sent from the application processor to the modem and reduce the amount of time that one or more interconnects of the UE 120 are active (for example, reducing the time that a PCIe or Universal Serial Bus (USB) interconnect is active and being used to exchange RST traffic associated with a closed TCP connection).

Furthermore, in some aspects, the modem may implement one or more techniques to reduce uplink RST traffic when the UE 120 receives a set of downlink packets included in the set of closed TCP connections and/or TCP connections for which an RST message has already been sent to the network node 110. For example, in a sixth operation 1060, a set of downlink packets transmitted by the network node 110 may be received at the UE 120. In a seventh operation 1070, the modem of the UE 120 may filter the downlink packets received from the network node 110 based on the downlink packets being associated with a TCP connection included in the set of closed TCP connections and/or TCP connections for which an RST message has already been sent to the network node 110. For example, in some aspects, the modem may discard all incoming downlink packets that are associated with a TCP connection included in the set of closed TCP connections and/or TCP connections for which an RST message has already been sent to the network node 110 to avoid any further downlink packets associated with a closed TCP connection or a previously reset TCP connection being delivered to the TCP/IP stack of the UE 120. In this way, the modem may discard the downlink packets that would otherwise trigger an uplink RST message for each downlink packet associated with a closed and/or previously reset TCP connection. Alternatively, in an eighth operation 1080, the modem may send one downlink packet out of every N downlink packets that are associated with a closed and/or previously reset TCP connection or one downlink packet associated with a closed and/or previously reset TCP connection every X ms. In this way, a small number of downlink packets may be delivered to the TCP/IP stack in the application processor to continue generating a small or moderate amount of uplink RST packets until the TCP connection closure status has been propagated to various entities in the end-to-end data path associated with the closed TCP connection(s).

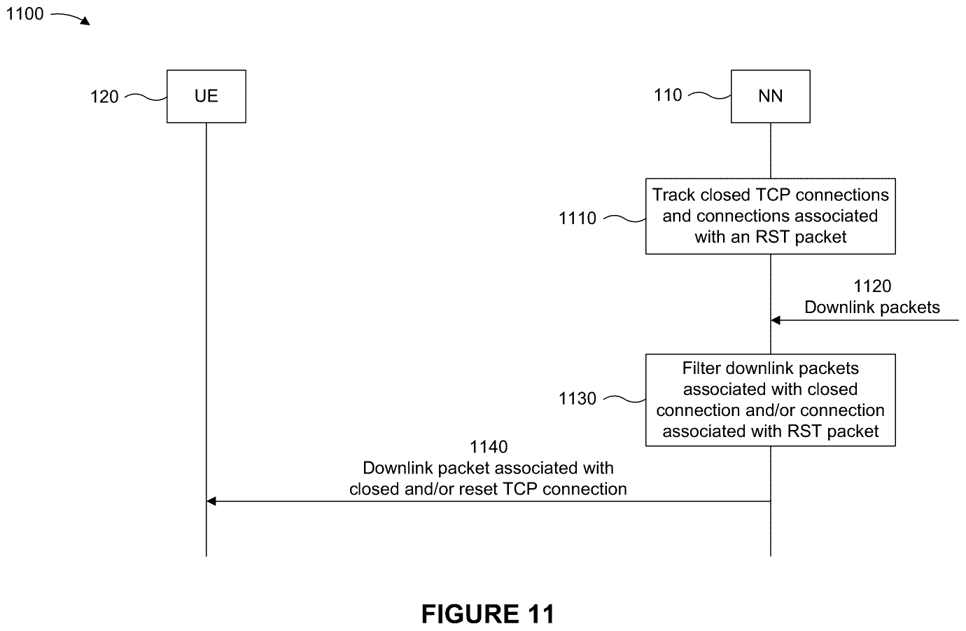

FIG. 11 is a diagram illustrating an example 1100 associated with TCP RST burst handling, in accordance with the present disclosure. As shown in FIG. 11, example 1100 includes communication between a UE 120 and a network node 110. In some aspects, the UE 120 and the network node 110 may communicate in a wireless network, such as wireless network 100. The UE 120 and the network node 110 may communicate via a wireless access link, which may include an uplink and a downlink.

As shown in FIG. 11, in a first operation 1110, the network node 110 may track a set of closed TCP connections and TCP connections associated with a previous RST packet transmission from the UE 120. For example, in some aspects, the network node 110 may include a modem equipped with capabilities to track one or more active TCP connections for various radio level enhancements, in a similar manner as described above for the UE 120. Accordingly, in some aspects, the network node 110 may be configured to track one or more closed TCP connections and/or TCP connections for which the UE 120 has transmitted an RST packet to the network node 110 in order to reduce downlink activity associated with such TCP connections. For example, when the modem of the network node 110 receives a FIN message or another suitable uplink message to close a TCP connection associated with the UE 120, the modem may store information that identifies the TCP connection. Similarly, when the modem of the network node 110 receives an RST message from the UE 120 (for example, in reply to a downlink packet that does not match an existing or active TCP connection associated with the UE 120), the network node 110 may store information that identifies the TCP connection associated with the RST message. Accordingly, the network node 110 may use TCP connection tracking capabilities to track a set of closed TCP connections, which may include one or more TCP connections that were closed within a threshold time period and/or one or more TCP connections associated with a previous uplink RST packet transmission. For example, in some aspects, the set of closed TCP connections may be tracked by storing a list or other suitable information that identifies the one or more TCP connections that were closed within a threshold time period and/or one or more TCP connections associated with a previous uplink RST packet transmission, which can then be used to reduce downlink traffic associated with closed and/or reset TCP connections.

For example, in a second operation 1120, the network node 110 may receive a set of downlink packets to be transmitted to the UE 120 (for example, from a CU or a core network device). Accordingly, in a third operation 1130, the network node 110 may filter the downlink packets based on the downlink packets being associated with a TCP connection included in the set of TCP connections that were recently closed and/or associated with a previous RST packet transmission. For example, in some aspects, the network node 110 may discard all downlink packets that are associated with a TCP connection included in the set of closed TCP connections and/or TCP connections for which an RST message has already been received from the UE 120 to avoid any further downlink packets associated with a closed TCP connection or a previously reset TCP connection being delivered to the TCP/IP stack of the UE 120. In this way, the modem may discard the downlink packets that would otherwise trigger an uplink RST message for each downlink packet associated with a closed and/or previously reset TCP connection, which may conserve radio resources (for example, associated with downlink scheduling, uplink scheduling, and/or interference) and conserve power associated with the UE 120. Alternatively, in a fourth operation 1140, the network node 110 may send one downlink packet out of every N downlink packets that are associated with a closed and/or previously reset TCP connection or may send one downlink packet associated with a closed and/or previously reset TCP connection to the UE 120 every X ms. In this way, a small number of downlink packets may be delivered to the TCP/IP stack of the UE 120 to allow a small or moderate amount of uplink RST traffic to be generated until the TCP connection closure status has been propagated to various entities in the end-to-end data path associated with the closed TCP connection(s).

FIG. 12 is a flowchart illustrating an example process 1200 performed, for example, by a UE that supports TCP RST burst handling in accordance with the present disclosure. Example process 1200 is an example where the UE (for example, UE 120) performs operations associated with TCP RST burst handling.

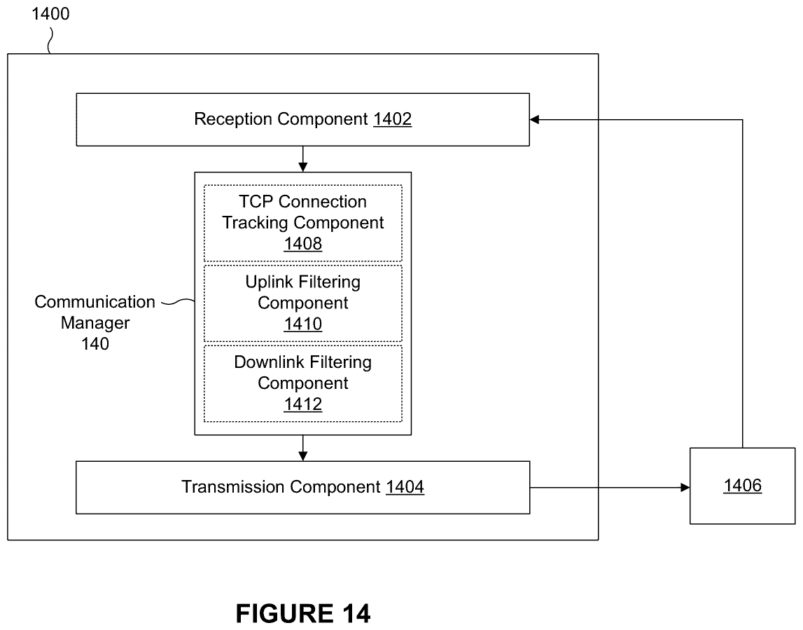

As shown in FIG. 12, in some aspects, process 1200 may include storing information identifying a set of closed TCP connections (block 1210). For example, the UE (such as by using communication manager 140 or TCP connection tracking component 1408, depicted in FIG. 14) may store information identifying a set of closed TCP connections, as described above.

As further shown in FIG. 12, in some aspects, process 1200 may include filtering a set of RST packets queued for uplink transmission by an application processor based at least in part on the set of RST packets being associated with a TCP connection included in the set of closed TCP connections (block 1220). For example, the UE (such as by using communication manager 140 or uplink filtering component 1410, depicted in FIG. 14) may filter a set of RST packets queued for uplink transmission by an application processor based at least in part on the set of RST packets being associated with a TCP connection included in the set of closed TCP connections, as described above.

As further shown in FIG. 12, in some aspects, process 1200 may include filtering a set of downlink packets, received from a network node, based at least in part on the set of downlink packets being associated with a TCP connection included in the set of closed TCP connections (block 1230). For example, the UE (such as by using communication manager 140 or downlink filtering component 1412, depicted in FIG. 14) may filter a set of downlink packets, received from a network node, based at least in part on the set of downlink packets being associated with a TCP connection included in the set of closed TCP connections, as described above.

Process 1200 may include additional aspects, such as any single aspect or any combination of aspects described below or in connection with one or more other processes described elsewhere herein.

In a first additional aspect, the set of closed TCP connections include one or more TCP connections that were closed within a threshold time period.

In a second additional aspect, alone or in combination with the first aspect, the set of closed TCP connections include one or more TCP connections associated with a previous uplink RST packet transmission.

In a third additional aspect, alone or in combination with one or more of the first and second aspects, filtering the set of RST packets queued for uplink transmission includes selecting, from the set of RST packets associated with the TCP connection, one RST packet to transmit to the network node, and pruning, from the set of RST packets associated with the TCP connection, all remaining RST packets associated with the TCP connection except for the one RST packet selected for transmission to the network node.

In a fourth additional aspect, alone or in combination with one or more of the first through third aspects, filtering the set of RST packets queued for uplink transmission includes selecting, from the set of RST packets associated with the TCP connection, one RST packet to transmit to the network node within a time period, and pruning, from the set of RST packets associated with the TCP connection, all remaining RST packets associated with the TCP connection that are queued for uplink transmission prior to the time period expiring.

In a fifth additional aspect, alone or in combination with one or more of the first through fourth aspects, process 1200 includes configuring the application processor to reduce a quantity of RST packets that are queued for uplink transmission for the TCP connection based at least in part on the application processor queuing the set of RST packets associated with the TCP connection.

In a sixth additional aspect, alone or in combination with one or more of the first through fifth aspects, filtering the set of downlink packets includes discarding each downlink packet in the set of downlink packets associated with the TCP connection based at least in part on the TCP connection being included in the set of closed TCP connections.

In a seventh additional aspect, alone or in combination with one or more of the first through sixth aspects, filtering the set of downlink packets includes selecting, from a quantity of the set of downlink packets associated with the TCP connection, one RST packet to forward to the application processor, and discarding all remaining downlink packets from the quantity of the set of downlink packets associated with the TCP connection.

In an eighth additional aspect, alone or in combination with one or more of the first through seventh aspects, filtering the set of downlink packets includes selecting, within a time period, one downlink packet in the set of downlink packets associated with the TCP connection to forward to the application processor, and discarding all remaining downlink packets associated with the TCP connection prior to the time period expiring.

Although FIG. 12 shows example blocks of process 1200, in some aspects, process 1200 may include additional blocks, fewer blocks, different blocks, or differently arranged blocks than those depicted in FIG. 12. Additionally or alternatively, two or more of the blocks of process 1200 may be performed in parallel.

FIG. 13 is a flowchart illustrating an example process 1300 performed, for example, by a network node that supports TCP RST burst handling in accordance with the present disclosure. Example process 1300 is an example where the network node (for example, network node 110) performs operations associated with TCP RST burst handling.

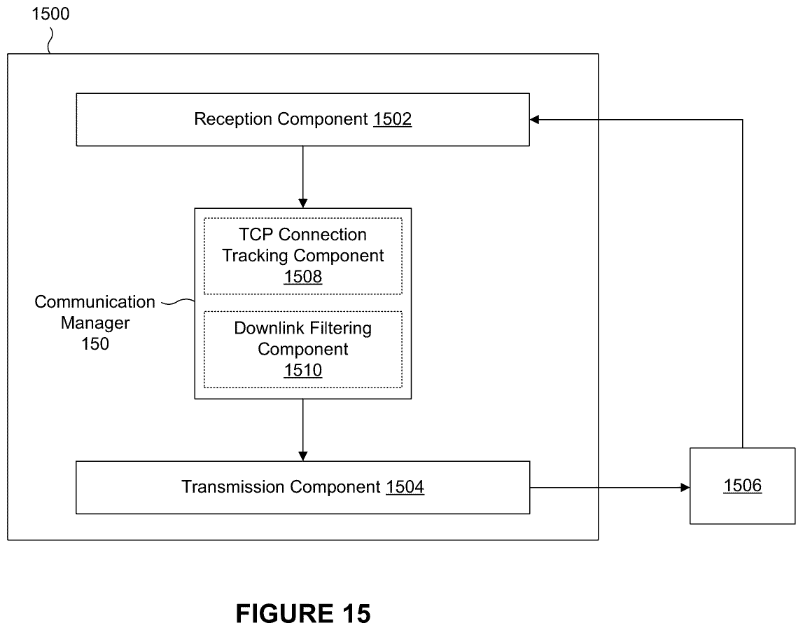

As shown in FIG. 13, in some aspects, process 1300 may include storing information identifying a set of TCP connections for which an uplink RST packet has been received from a UE (block 1310). For example, the network node (such as by using communication manager 150 or TCP connection tracking component 1508, depicted in FIG. 15) may store information identifying a set of TCP connections for which an uplink RST packet has been received from a UE, as described above.

As further shown in FIG. 13, in some aspects, process 1300 may include filtering a set of downlink packets that are queued for downlink transmission to the UE based at least in part on the set of downlink packets being associated with a TCP connection included in the set of TCP connections for which an uplink RST packet has been received from the UE (block 1320). For example, the network node (such as by using communication manager 150 or downlink filtering component 1510, depicted in FIG. 15) may filter a set of downlink packets that are queued for downlink transmission to the UE based at least in part on the set of downlink packets being associated with a TCP connection included in the set of TCP connections for which an uplink RST packet has been received from the UE, as described above.

Process 1300 may include additional aspects, such as any single aspect or any combination of aspects described below or in connection with one or more other processes described elsewhere herein.

In a first additional aspect, filtering the set of downlink packets includes discarding each downlink packet in the set of downlink packets associated with the TCP connection based at least in part on the TCP connection being included in the set of TCP connections for which an uplink RST packet has been received from the UE.

In a second additional aspect, alone or in combination with the first aspect, filtering the set of downlink packets includes transmitting, from a quantity of the set of downlink packets associated with the TCP connection, one RST packet to the UE, and discarding all remaining downlink packets from the quantity of the set of downlink packets associated with the TCP connection.

In a third additional aspect, alone or in combination with one or more of the first and second aspects, filtering the set of downlink packets includes transmitting, within a time period, one downlink packet in the set of downlink packets associated with the TCP connection to the UE, and discarding all remaining downlink packets associated with the TCP connection prior to the time period expiring.

Although FIG. 13 shows example blocks of process 1300, in some aspects, process 1300 may include additional blocks, fewer blocks, different blocks, or differently arranged blocks than those depicted in FIG. 13. Additionally or alternatively, two or more of the blocks of process 1300 may be performed in parallel.

FIG. 14 is a diagram of an example apparatus 1400 for wireless communication that supports TCP RST burst handling in accordance with the present disclosure. The apparatus 1400 may be a UE, or a UE may include the apparatus 1400. In some aspects, the apparatus 1400 includes a reception component 1402, a transmission component 1404, and a communication manager 140, which may be in communication with one another (for example, via one or more buses). As shown, the apparatus 1400 may communicate with another apparatus 1406 (such as a UE, a network node, or another wireless communication device) using the reception component 1402 and the transmission component 1404.

In some aspects, the apparatus 1400 may be configured to and/or operable to perform one or more operations described herein in connection with FIGS. 10-11. Additionally or alternatively, the apparatus 1400 may be configured to and/or operable to perform one or more processes described herein, such as process 1200 of FIG. 12. In some aspects, the apparatus 1400 may include one or more components of the UE described above in connection with FIG. 2.

The reception component 1402 may receive communications, such as reference signals, control information, and/or data communications, from the apparatus 1406. The reception component 1402 may provide received communications to one or more other components of the apparatus 1400, such as the communication manager 140. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1402 may include one or more antennas, a modem, a demodulator, a MIMO detector, a receive processor, a controller/processor, and/or a memory of the UE described above in connection with FIG. 2.

The transmission component 1404 may transmit communications, such as reference signals, control information, and/or data communications, to the apparatus 1406. In some aspects, the communication manager 140 may generate communications and may transmit the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, and/or a memory of the UE described above in connection with FIG. 2. In some aspects, the transmission component 1404 may be co-located with the reception component 1402 in a transceiver.

The communication manager 140 may store information identifying a set of closed TCP connections. The communication manager 140 may filter a set of RST packets queued for uplink transmission by an application processor based at least in part on the set of RST packets being associated with a TCP connection included in the set of closed TCP connections. The communication manager 140 may filter a set of downlink packets, received from a network node, based at least in part on the set of downlink packets being associated with a TCP connection included in the set of closed TCP connections. In some aspects, the communication manager 140 may perform one or more operations described elsewhere herein as being performed by one or more components of the communication manager 140.

The communication manager 140 may include a controller/processor and/or a memory of the UE described above in connection with FIG. 2. In some aspects, the communication manager 140 includes a set of components, such as a TCP connection tracking component 1408, an uplink filtering component 1410, and/or a downlink filtering component 1412. Alternatively, the set of components may be separate and distinct from the communication manager 140. In some aspects, one or more components of the set of components may include or may be implemented within a controller/processor and/or a memory of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The TCP connection tracking component 1408 may store information identifying a set of closed TCP connections. The uplink filtering component 1410 may filter a set of RST packets queued for uplink transmission by an application processor based at least in part on the set of RST packets being associated with a TCP connection included in the set of closed TCP connections. The downlink filtering component 1412 may filter a set of downlink packets, received from a network node, based at least in part on the set of downlink packets being associated with a TCP connection included in the set of closed TCP connections.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally or alternatively, a set of (one or more) components shown in FIG. 14 may perform one or more functions described as being performed by another set of components shown in FIG. 14.

FIG. 15 is a diagram of an example apparatus 1500 for wireless communication that supports TCP RST burst handling in accordance with the present disclosure. The apparatus 1500 may be a network node, or a network node may include the apparatus 1500. In some aspects, the apparatus 1500 includes a reception component 1502, a transmission component 1504, and a communication manager 150, which may be in communication with one another (for example, via one or more buses). As shown, the apparatus 1500 may communicate with another apparatus 1506 (such as a UE, a network node, or another wireless communication device) using the reception component 1502 and the transmission component 1504.

In some aspects, the apparatus 1500 may be configured to and/or operable to perform one or more operations described herein in connection with FIGS. 10-11. Additionally or alternatively, the apparatus 1500 may be configured to and/or operable to perform one or more processes described herein, such as process 1300 of FIG. 13. In some aspects, the apparatus 1500 may include one or more components of the network node described above in connection with FIG. 2.

The reception component 1502 may receive communications, such as reference signals, control information, and/or data communications, from the apparatus 1506. The reception component 1502 may provide received communications to one or more other components of the apparatus 1500, such as the communication manager 150. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1502 may include one or more antennas, a modem, a demodulator, a MIMO detector, a receive processor, a controller/processor, and/or a memory of the network node described above in connection with FIG. 2.

The transmission component 1504 may transmit communications, such as reference signals, control information, and/or data communications, to the apparatus 1506. In some aspects, the communication manager 150 may generate communications and may transmit the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, and/or a memory of the network node described above in connection with FIG. 2. In some aspects, the transmission component 1504 may be co-located with the reception component 1502 in a transceiver.

The communication manager 150 may store information identifying a set of TCP connections for which an uplink RST packet has been received from a UE. The communication manager 150 may filter a set of downlink packets that are queued for downlink transmission to the UE based at least in part on the set of downlink packets being associated with a TCP connection included in the set of TCP connections for which an uplink RST packet has been received from the UE. In some aspects, the communication manager 150 may perform one or more operations described elsewhere herein as being performed by one or more components of the communication manager 150.

The communication manager 150 may include a controller/processor, a memory, a scheduler, and/or a communication unit of the network node described above in connection with FIG. 2. In some aspects, the communication manager 150 includes a set of components, such as a TCP connection tracking component 1508 and/or a downlink filtering component 1510. Alternatively, the set of components may be separate and distinct from the communication manager 150. In some aspects, one or more components of the set of components may include or may be implemented within a controller/processor, a memory, a scheduler, and/or a communication unit of the network node described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The TCP connection tracking component 1508 may store information identifying a set of TCP connections for which an uplink RST packet has been received from a UE. The downlink filtering component 1510 may filter a set of downlink packets that are queued for downlink transmission to the UE based at least in part on the set of downlink packets being associated with a TCP connection included in the set of TCP connections for which an uplink RST packet has been received from the UE.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally or alternatively, a set of (one or more) components shown in FIG. 15 may perform one or more functions described as being performed by another set of components shown in FIG. 15.

The following provides an overview of some Aspects of the present disclosure:
Aspect 1: A method of wireless communication performed by a UE, comprising: storing information identifying a set of closed TCP connections; filtering a set of RST packets queued for uplink transmission by an application processor based at least in part on the set of RST packets being associated with a TCP connection included in the set of closed TCP connections; and filtering a set of downlink packets, received from a network node, based at least in part on the set of downlink packets being associated with a TCP connection included in the set of closed TCP connections.
Aspect 2: The method of Aspect 1, wherein the set of closed TCP connections include one or more TCP connections that were closed within a threshold time period.
Aspect 3: The method of any of Aspects 1-2, wherein the set of closed TCP connections include one or more TCP connections associated with a previous uplink RST packet transmission.
Aspect 4: The method of any of Aspects 1-3, wherein filtering the set of RST packets queued for uplink transmission includes: selecting, from the set of RST packets associated with the TCP connection, one RST packet to transmit to the network node; and pruning, from the set of RST packets associated with the TCP connection, all remaining RST packets associated with the TCP connection except for the one RST packet selected for transmission to the network node.
Aspect 5: The method of any of Aspects 1-4, wherein filtering the set of RST packets queued for uplink transmission includes: selecting, from the set of RST packets associated with the TCP connection, one RST packet to transmit to the network node within a time period; and pruning, from the set of RST packets associated with the TCP connection, all remaining RST packets associated with the TCP connection that are queued for uplink transmission prior to the time period expiring.
Aspect 6: The method of any of Aspects 1-5, further comprising: configuring the application processor to reduce a quantity of RST packets that are queued for uplink transmission for the TCP connection based at least in part on the application processor queuing the set of RST packets associated with the TCP connection.
Aspect 7: The method of any of Aspects 1-6, wherein filtering the set of downlink packets includes: discarding each downlink packet in the set of downlink packets associated with the TCP connection based at least in part on the TCP connection being included in the set of closed TCP connections.
Aspect 8: The method of any of Aspects 1-7, wherein filtering the set of downlink packets includes: selecting, from a quantity of the set of downlink packets associated with the TCP connection, one RST packet to forward to the application processor; and discarding all remaining downlink packets from the quantity of the set of downlink packets associated with the TCP connection.
Aspect 9: The method of any of Aspects 1-8, wherein filtering the set of downlink packets includes: selecting, within a time period, one downlink packet in the set of downlink packets associated with the TCP connection to forward to the application processor; and discarding all remaining downlink packets associated with the TCP connection prior to the time period expiring.
Aspect 10: A method of wireless communication performed by a network node, comprising: storing information identifying a set of TCP connections for which an uplink RST packet has been received from a UE; and filtering a set of downlink packets that are queued for downlink transmission to the UE based at least in part on the set of downlink packets being associated with a TCP connection included in the set of TCP connections for which an uplink RST packet has been received from the UE.
Aspect 11: The method of Aspect 10, wherein filtering the set of downlink packets includes: discarding each downlink packet in the set of downlink packets associated with the TCP connection based at least in part on the TCP connection being included in the set of TCP connections for which an uplink RST packet has been received from the UE.
Aspect 12: The method of any of Aspects 10-11, wherein filtering the set of downlink packets includes: transmitting, from a quantity of the set of downlink packets associated with the TCP connection, one RST packet to the UE; and discarding all remaining downlink packets from the quantity of the set of downlink packets associated with the TCP connection.
Aspect 13: The method of any of Aspects 10-12, wherein filtering the set of downlink packets includes: transmitting, within a time period, one downlink packet in the set of downlink packets associated with the TCP connection to the UE; and discarding all remaining downlink packets associated with the TCP connection prior to the time period expiring.
Aspect 14: An apparatus for wireless communication at a device, comprising a processor; memory coupled with the processor; and instructions stored in the memory and executable by the processor to cause the apparatus to perform the method of one or more of Aspects 1-13.
Aspect 15: A device for wireless communication, comprising a memory and one or more processors coupled to the memory, the one or more processors configured to perform the method of one or more of Aspects 1-13.
Aspect 16: An apparatus for wireless communication, comprising at least one means for performing the method of one or more of Aspects 1-13.
Aspect 17: A non-transitory computer-readable medium storing code for wireless communication, the code comprising instructions executable by a processor to perform the method of one or more of Aspects 1-13.
Aspect 18: A non-transitory computer-readable medium storing a set of instructions for wireless communication, the set of instructions comprising one or more instructions that, when executed by one or more processors of a device, cause the device to perform the method of one or more of Aspects 1-13.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A user equipment (UE) for wireless communication, comprising:
at least one memory; and
at least one processor coupled with the at least one memory, the at least one processor operable to cause the UE to:
store information identifying a set of closed transmission control protocol (TCP) connections;
filter a set of reset (RST) packets queued for uplink transmission by an application processor based at least in part on the set of RST packets being associated with a TCP connection included in the set of closed TCP connections; and
filter a set of downlink packets, received from a network node, based at least in part on the set of downlink packets being associated with a TCP connection included in the set of closed TCP connections.

2. The UE of claim 1, wherein the set of closed TCP connections include one or more TCP connections that were closed within a threshold time period or one or more TCP connections associated with a previous uplink RST packet transmission.

3. The UE of claim 1, wherein, to cause the UE to filter the set of RST packets queued for uplink transmission, the at least one processor is operable to cause the UE to:
select, from the set of RST packets associated with the TCP connection, one RST packet to transmit to the network node; and
prune, from the set of RST packets associated with the TCP connection, all remaining RST packets associated with the TCP connection except for the one RST packet selected for transmission to the network node.

4. The UE of claim 1, wherein, to cause the UE to filter the set of RST packets queued for uplink transmission, the at least one processor is operable to cause the UE to:
select, from the set of RST packets associated with the TCP connection, one RST packet to transmit to the network node within a time period; and
prune, from the set of RST packets associated with the TCP connection, all remaining RST packets associated with the TCP connection that are queued for uplink transmission prior to the time period expiring.

5. The UE of claim 1, wherein the at least one processor is further operable to cause the UE to:
configure the application processor to reduce a quantity of RST packets that are queued for uplink transmission for the TCP connection based at least in part on the application processor queuing the set of RST packets associated with the TCP connection.

6. The UE of claim 1, wherein, to cause the UE to filter the set of downlink packets, the at least one processor is operable to cause the UE to:
discard each downlink packet in the set of downlink packets associated with the TCP connection based at least in part on the TCP connection being included in the set of closed TCP connections.

7. The UE of claim 1, wherein, to cause the UE to filter the set of downlink packets, the at least one processor is operable to cause the UE to:
select, from a quantity of the set of downlink packets associated with the TCP connection, one RST packet to forward to the application processor; and
discard all remaining downlink packets from the quantity of the set of downlink packets associated with the TCP connection.

8. The UE of claim 1, wherein, to cause the UE to filter the set of downlink packets, the at least one processor is operable to cause the UE to:
select, within a time period, one downlink packet in the set of downlink packets associated with the TCP connection to forward to the application processor; and
discard all remaining downlink packets associated with the TCP connection prior to the time period expiring.

9. A network node for wireless communication, comprising:
at least one memory; and
at least one processor coupled with the at least one memory, the at least one processor operable to cause the network node to:
store information identifying a set of transmission control protocol (TCP) connections for which an uplink reset (RST) packet has been received from a user equipment (UE); and
filter a set of downlink packets that are queued for downlink transmission to the UE based at least in part on the set of downlink packets being associated with a TCP connection included in the set of TCP connections for which an uplink RST packet has been received from the UE.

10. The network node of claim 9, wherein, to cause the network node to filter the set of downlink packets, the at least one processor is operable to cause the network node to:
discard each downlink packet in the set of downlink packets associated with the TCP connection based at least in part on the TCP connection being included in the set of TCP connections for which an uplink RST packet has been received from the UE.

11. The network node of claim 9, wherein, to cause the network node to filter the set of downlink packets, the at least one processor is operable to cause the network node to:
transmit, from a quantity of the set of downlink packets associated with the TCP connection, one RST packet to the UE; and
discard all remaining downlink packets from the quantity of the set of downlink packets associated with the TCP connection.

12. The network node of claim 9, wherein, to cause the network node to filter the set of downlink packets, the at least one processor is operable to cause the network node to:
transmit, within a time period, one downlink packet in the set of downlink packets associated with the TCP connection to the UE; and
discard all remaining downlink packets associated with the TCP connection prior to the time period expiring.

13. A method of wireless communication performed by a user equipment (UE), comprising:
storing information identifying a set of closed transmission control protocol (TCP) connections;
filtering a set of reset (RST) packets queued for uplink transmission by an application processor based at least in part on the set of RST packets being associated with a TCP connection included in the set of closed TCP connections; and
filtering a set of downlink packets, received from a network node, based at least in part on the set of downlink packets being associated with a TCP connection included in the set of closed TCP connections.

14. The method of claim 13, wherein the set of closed TCP connections include one or more TCP connections that were closed within a threshold time period or one or more TCP connections associated with a previous uplink RST packet transmission.

15. The method of claim 13, wherein filtering the set of RST packets queued for uplink transmission includes:
selecting, from the set of RST packets associated with the TCP connection, one RST packet to transmit to the network node; and
pruning, from the set of RST packets associated with the TCP connection, all remaining RST packets associated with the TCP connection except for the one RST packet selected for transmission to the network node.

16. The method of claim 13, wherein filtering the set of RST packets queued for uplink transmission includes:
selecting, from the set of RST packets associated with the TCP connection, one RST packet to transmit to the network node within a time period; and
pruning, from the set of RST packets associated with the TCP connection, all remaining RST packets associated with the TCP connection that are queued for uplink transmission prior to the time period expiring.

17. The method of claim 13, further comprising:
configuring the application processor to reduce a quantity of RST packets that are queued for uplink transmission for the TCP connection based at least in part on the application processor queuing the set of RST packets associated with the TCP connection.

18. The method of claim 13, wherein filtering the set of downlink packets includes:
discarding each downlink packet in the set of downlink packets associated with the TCP connection based at least in part on the TCP connection being included in the set of closed TCP connections.

19. The method of claim 13, wherein filtering the set of downlink packets includes:
selecting, from a quantity of the set of downlink packets associated with the TCP connection, one RST packet to forward to the application processor; and
discarding all remaining downlink packets from the quantity of the set of downlink packets associated with the TCP connection.

20. The method of claim 13, wherein filtering the set of downlink packets includes:
selecting, within a time period, one downlink packet in the set of downlink packets associated with the TCP connection to forward to the application processor; and
discarding all remaining downlink packets associated with the TCP connection prior to the time period expiring.
